(19) United States
(12) Patent Application Publication
(10) Pub. No.: US 2014/0256270 A1
(43) Pub. Date: Sep. 11, 2014

(54) METHODS OF CONTROLLING RESONANCE FREQUENCIES IN NEAR FIELD COMMUNICATION DEVICES, NEAR FIELD COMMUNICATION DEVICES AND ELECTRONIC SYSTEMS HAVING THE SAME

(71) Applicants: Jong-Pil CHO, Hwaseong-si (KR); Il-Jong SONG, Yongin-si (KR); Min-Woo LEE, Incheon (KR)

(72) Inventors: Jong-Pil CHO, Hwaseong-si (KR); Il-Jong SONG, Yongin-si (KR); Min-Woo LEE, Incheon (KR)

(21) Appl. No.: 14/200,242

(22) Filed: Mar. 7, 2014

(30) Foreign Application Priority Data
Mar. 7, 2013 (KR) 10-2013-0024497

(51) Int. Cl. H04B 5/02

(52) U.S. Cl. CPC H04B 5/02
USPC 455/77

(57) ABSTRACT

A method of controlling a resonance frequency of a Near Field Communication (NFC) device that includes a resonance unit to transceive data through an electromagnetic wave and an NFC chip may comprise: detecting whether an NFC card or reader exists around the NFC device; when the NFC card is detected, setting a resonance frequency of the resonance unit as a first optimal frequency based on a magnitude of a voltage generated from the resonance unit while a carrier wave is radiated to the NFC card through the resonance unit; and/or when the NFC reader is detected, setting the resonance frequency of the resonance unit as a second optimal frequency based on the magnitude of the voltage generated from the resonance unit in response to the wave received from the NFC reader and/or a magnitude of an inner current generated from the NFC chip in response to the wave.

### CROSS-REFERENCE TO RELATED APPLICATION(S)

This application claims priority from Korean Patent Application No. 10-2013-0024497, filed on Mar. 7, 2013, in the Korean Intellectual Property Office (KIPO), the entire contents of which are incorporated herein by reference.

### BACKGROUND

1. Field

Some example embodiments may relate generally to wireless communication technology. Some example embodiments may relate generally to methods of controlling resonance frequencies of near field communication (NFC) devices, NFC devices, and/or electronic systems having the same.

2. Description of Related Art

Recently, as a near field communication (NFC) technology, which is one of wireless communication technologies, has been developed, an NFC device is extensively employed in mobile devices.

Since the NFC device uses a resonance circuit, the NFC device performs communication by matching the resonance frequencies of the NFC devices.

However, if the resonance frequency matching is not achieved between the NFC devices, the communication performance is deteriorated.

### SUMMARY

Some example embodiments may provide methods of controlling resonance frequencies of NFC devices that can tune resonance frequencies to optimal frequencies.

Some example embodiments may provide NFC devices that can tune resonance frequencies to optimal frequencies.

Some example embodiments may provide electronic systems including the NFC devices.

In some example embodiments, a method of controlling a resonance frequency of a Near Field Communication (NFC) device that includes a resonance unit to transceive data through an electromagnetic wave and an NFC chip may comprise: detecting whether an NFC card or an NFC reader exists around the NFC device; when the NFC card is detected, setting a resonance frequency of the resonance unit as a first optimal frequency based on a magnitude of a voltage generated from the resonance unit while a carrier wave is radiated to the NFC card through the resonance unit; and/or when the NFC reader is detected, setting the resonance frequency of the resonance unit as a second optimal frequency based on at least one of the magnitude of the voltage generated from the resonance unit in response to the electromagnetic wave received from the NFC reader and a magnitude of an inner current generated from the NFC chip in response to the electromagnetic wave.

In some example embodiments, the setting the resonance frequency as the first optimal frequency may comprise: continuously radiating the carrier wave to the NFC card through the resonance unit; repeatedly measuring a first voltage generated from the resonance unit while varying the resonance frequency during radiation of the carrier wave; determining the first optimal frequency based on the resonance frequency obtained when the first voltage becomes a maximum voltage from among the measured voltages; and/or adjusting the resonance frequency to the first optimal frequency.

In some example embodiments, the repeatedly measuring the first voltage while varying the resonance frequency may comprise: sequentially increasing a capacitance of a capacitive load connected to the resonance unit; and/or measuring the first voltage with respect to each capacitance of the capacitive load.

In some example embodiments, the measuring the first voltage may comprise: generating a count value by performing an up-counting operation; generating a scanning voltage that is sequentially increased based on the count value; comparing a magnitude of the first voltage with a magnitude of the scanning voltage; and/or generating the count value obtained at a time when the magnitude of the scanning voltage is greater than or equal to the magnitude of the first voltage as a digital value.

In some example embodiments, the determining the first optimal frequency based on the resonance frequency obtained when the first voltage becomes the maximum voltage from among the measured voltages may comprise determining the capacitance of the capacitive load obtained when the digital value is maximized as a first optimal capacitance by comparing the digital values generated with respect to each capacitance of the capacitive load. The adjusting the resonance frequency to the first optimal frequency may comprise setting the capacitance of the capacitive load into the first optimal capacitance.

In some example embodiments, the determining the first optimal frequency based on the resonance frequency obtained when the first voltage becomes the maximum voltage from among the measured voltages may comprise determining a value, which is obtained by adding a first offset capacitance to the capacitance of the capacitive load obtained when the digital value is maximized from among the digital values generated with respect to each capacitance of the capacitive load, as a first optimal capacitance. The adjusting the resonance frequency to the first optimal frequency may comprise adjusting the capacitance of the capacitive load to the first optical capacitance.

In some example embodiments, the setting the resonance frequency as the second optimal frequency may comprise: repeatedly measuring one selected from a second voltage, which is generated from the resonance unit in response to the electromagnetic wave received from the NFC reader, and the inner current while varying the resonance frequency; determining the second optimal frequency based on the resonance frequency obtained when the selected one is maximized; and/or adjusting the resonance frequency to the second optimal frequency.

In some example embodiments, detecting whether the NFC card or the NFC reader exists around the NFC device may comprise: determining that the NFC card is detected when a voltage, which is generated from the resonance unit while the carrier wave having a standard voltage is periodically radiated through the resonance unit, is lower than the standard voltage by a first threshold voltage or more; and/or determining that the NFC reader is detected when a voltage, which is generated from the resonance unit in response to an electromagnetic wave received from outside the NFC device and is periodically measured, is greater than or equal to a second threshold voltage.

In some example embodiments, the determining that the NFC card is detected and the determining that the NFC reader is detected may be performed repeatedly and alternately until the NFC card or the NFC reader is detected.

In some example embodiments, the method may further comprise: transmitting a request instruction to the NFC card; and/or repeatedly performing the setting the resonance frequency as the first optical frequency when a response to the request instruction is not received from the NFC card during a first time period.

In some example embodiments, the method may further comprise repeatedly performing the setting the resonance frequency as the second optical frequency when a request instruction is not received from the NFC reader during a first time period.

In some example embodiments, a Near Field Communication (NFC) device may comprise: a resonance unit configured to generate a field voltage in response to an electromagnetic wave; and/or an NFC chip configured to detect whether an NFC card or an NFC reader exists around the NFC device based on a magnitude of the field voltage, configured to set a resonance frequency of the resonance unit as a first optimal frequency based on the magnitude of the field voltage and to operate in a reader mode when the NFC card is detected, and configured to set the resonance frequency of the resonance unit as a second optimal frequency based on at least one of the magnitude of the field voltage and a magnitude of an inner current generated in response to the electromagnetic wave and to operate in a card mode when the NFC reader is detected.

In some example embodiments, the NFC chip may comprise: a transmit unit configured to provide a carrier signal to the resonance unit through a transmit terminal; a power generation unit configured to generate the inner current and an inner voltage having a desired voltage level using a voltage provided from the resonance unit; a detection unit configured to convert one of the magnitude of the field voltage and the magnitude of the inner current into a digital value; a tuning unit configured to connect a capacitive load having a capacitance corresponding to a tuning control signal to the resonance unit; and/or a Central Processing Unit (CPU) configured to control the transmit unit, the detection unit, and the tuning unit, to detect the NFC card based on the digital value and a first threshold voltage, to detect the NFC reader based on the digital value and a second threshold voltage, to generate the tuning control signal corresponding to the first optimal frequency based on the digital value in the reader mode, and to generate the tuning control signal corresponding to the second optimal frequency based on the digital value in the card mode.

In some example embodiments, the tuning unit may be further configured to connect the capacitive load between a terminal receiving the field voltage from the resonance unit and a ground voltage.

In some example embodiments, the tuning unit may be further configured to connect the capacitive load between the transmit terminal and a ground voltage.

In some example embodiments, the transmit unit may be further configured to periodically provide the carrier signal to the resonance unit while detecting the NFC card, the detection unit may be further configured to receive the field voltage from the resonance unit to generate the digital value while the resonance unit radiates a carrier wave corresponding to the carrier signal, and/or the CPU may be further configured to determine that the NFC card is detected when a voltage corresponding to the digital value is lower than a standard voltage by the first threshold voltage or more.

In some example embodiments, the detection unit may be further configured to receive the field voltage from the resonance unit to generate the digital value while detecting the NFC reader, and/or the CPU may be further configured to determine that the NFC reader is detected when a voltage corresponding to the digital value is greater than or equal to the second threshold voltage.

In some example embodiments, the transmit unit may be further configured to continuously provide the carrier signal to the resonance unit when the NFC card is detected, the CPU may be further configured to generate the tuning control signal having a value sequentially increased, the tuning unit may be further configured to sequentially increase the capacitance of the capacitive load based on the tuning control signal, the detection unit may be further configured to generate the digital value based on the field voltage whenever a value of the tuning control signal is increased, and/or the CPU may be further configured to compare the digital values generated with respect to each value of the tuning control signal with each other and provide the tuning unit with the tuning control signal having the value of the tuning control signal when the digital value is maximized.

In some example embodiments, the CPU may be further configured to generate the tuning control signal having a value sequentially increased when the NFC reader is detected, the tuning unit may be further configured to sequentially increase the capacitance of the capacitive load based on the tuning control signal, the detection unit may be further configured to generate the digital value based on one of the field voltage and the inner current whenever a value of the tuning control signal is increased, and/or the CPU may be further configured to compare the digital values generated with respect to each value of the tuning control signal with each other and provide the tuning unit with the tuning control signal having the value of the tuning control signal when the digital value is maximized.

In some example embodiments, the detection unit may comprise: a sensing unit configured to generate a first direct current (DC) voltage proportional to the magnitude of the field voltage and a gain signal; a current-voltage conversion unit configured to generate a second DC voltage proportional to the magnitude of the inner current and the gain signal; a multiplexer configured to output one of the first and second DC voltages in response to a selection signal; a counting unit configured to generate a counting value by performing an up-counting operation; a scanning voltage generation unit configured to generate a scanning voltage that is sequentially increased based on the counting value; a comparator configured to output a comparison signal having a first logic level when an output voltage of the multiplexer is greater than the scanning voltage and a second logic level when the output voltage of the multiplexer is less than the scanning voltage; and/or a latch unit configured to store the counting value as the digital value in response to a transition of the comparison signal.

In some example embodiments, the CPU may be further configured to provide the gain signal having a first value to the sensing unit during a section of detecting the NFC card and in the reader mode, and/or the CPU may be further configured to provide the gain signal having a second value to the sensing unit during a section of detecting the NFC reader and in the card mode.

In some example embodiments, the sensing unit may comprise: a rectifier circuit configured to rectify the field voltage to output the rectified field voltage to a first node; a first resistor connected between the first node and a second node; and/or a first variable resistor connected between the second node and a ground voltage and having a resistance value with a magnitude corresponding to the gain signal. The sensing unit may be further configured to output the first DC voltage through the second node.

In some example embodiments, the sensing unit may comprise: a rectifier circuit configured to rectify the field voltage to output the rectified field voltage to a first node; and/or a variable current source connected between the first node and a ground voltage to generate a current having a magnitude corresponding to the gain signal. The sensing unit may be further configured to output the first DC voltage through the first node.

In some example embodiments, the scanning voltage generation unit may comprise: a reference voltage generator configured to generate a reference voltage; a second resistor connected between the reference voltage generator and a third node; and/or a second variable resistor connected between the third node and a ground voltage. The scanning voltage generation unit may output the scanning voltage through the third node.

In some example embodiments, an electronic system may comprise: a memory unit configured to store data; a Near Field Communication (NFC) device configured to transmit the data stored in the memory unit through NFC and to store data received from outside the NFC device in the memory unit; and/or an application processor configured to control operations of the NFC device and the memory unit. The NFC device may comprise: a resonance unit configured to generate a field voltage in response to an electromagnetic wave; and/or an NFC chip configured to detect whether an NFC card or an NFC reader exists around the NFC device based on a magnitude of the field voltage, configured to set a resonance frequency of the resonance unit as a first optimal frequency based on the magnitude of the field voltage and to operate in a reader mode when the NFC card is detected, and configured to set the resonance frequency of the resonance unit as a second optimal frequency based on at least one of the magnitude of the field voltage and a magnitude of an inner current generated in response to the electromagnetic wave and to operate in a card mode when the NFC reader is detected.

In some example embodiments, a method of controlling a resonance frequency of a Near Field Communication (NFC) device that includes a resonance unit to transceive data through an electromagnetic wave and an NFC chip may comprise: detecting whether an NFC card or an NFC reader exists within a communication range of the NFC device; when the NFC card is detected, setting a resonance frequency of the resonance unit as a first frequency based on a magnitude of a voltage generated from the resonance unit while a carrier wave is radiated to the NFC card through the resonance unit; and/or when the NFC reader is detected, setting the resonance frequency of the resonance unit as a second frequency based on at least one of the magnitude of the voltage generated from the resonance unit in response to the electromagnetic wave received from the NFC reader and a magnitude of an inner current generated from the NFC chip in response to the electromagnetic wave.

In some example embodiments, the first frequency may be different from the second frequency.

In some example embodiments, when the NFC card is detected, the resonance frequency of the resonance unit may be set as the first frequency is based on a maximum magnitude of the voltage generated from the resonance unit while the carrier wave is radiated to the NFC card through the resonance unit.

In some example embodiments, when the NFC reader is detected, the resonance frequency of the resonance unit may be set as the second frequency based on at least one of a maximum magnitude of the voltage generated from the resonance unit in response to the electromagnetic wave received from the NFC reader and the magnitude of the inner current generated from the NFC chip in response to the electromagnetic wave.

In some example embodiments, when the NFC reader is detected, the resonance frequency of the resonance unit may be set as the second frequency based on at least one of the magnitude of the voltage generated from the resonance unit in response to the electromagnetic wave received from the NFC reader and a maximum magnitude of the inner current generated from the NFC chip in response to the electromagnetic wave.

In some example embodiments, when the NFC reader is detected, the resonance frequency of the resonance unit may be set as the second frequency based on at least one of a maximum magnitude of the voltage generated from the resonance unit in response to the electromagnetic wave received from the NFC reader and a maximum magnitude of the inner current generated from the NFC chip in response to the electromagnetic wave.

### BRIEF DESCRIPTION OF THE DRAWINGS

The above and/or other aspects and advantages will become more apparent and more readily appreciated from the following detailed description of example embodiments, taken in conjunction with the accompanying drawings, in which:

FIG. 1 is a flowchart illustrating a method of controlling a resonance frequency of a Near Field Communication (NFC) device according to some example embodiments;

FIG. 2 is a flowchart illustrating one example of a step of detecting whether the NFC card or the NFC reader exists around;

FIG. 3 is a view illustrating a step of detecting an NFC card;

FIG. 4 is a view illustrating a step of detecting an NFC reader of FIG. 2;

FIG. 5 is a flowchart illustrating one example of a step of setting a resonance frequency of a resonance unit as a first optimal frequency when the NFC card is detected in FIG. 1;

FIG. 6 is a flowchart illustrating one example of a step of setting a resonance frequency of the resonance unit as the second optimal frequency when an NFC reader is detected in FIG. 1;

FIG. 7 is a graph illustrating an effect of the method of controlling a resonance frequency of the NFC device of FIG. 1;

FIG. 8 is a block diagram illustrating an NFC device according to some example embodiments;

FIG. 9 is a block diagram illustrating one example of the NFC device depicted in FIG. 8;

FIG. 10 is a block diagram illustrating one example of the power generation unit included in the NFC device of FIG. 9;

FIG. 11 is a block diagram illustrating another example of the power generation unit included in the NFC device of FIG. 9;

FIG. 12 is a block diagram illustrating one example of the tuning unit included in the NFC device of FIG. 9;

FIG. 13 is a block diagram illustrating one example of the detection unit included in the NFC device of FIG. 9;

FIG. 14 is a block diagram illustrating one example of the sensing unit included in the detection unit of FIG. 13;

FIG. 15 is a block diagram illustrating another example of the sensing unit included in the detection unit of FIG. 13;

FIG. 16 is a block diagram illustrating one example of the scanning voltage generation unit included in the detection unit of FIG. 13;

FIG. 17 is a block diagram illustrating another example of the NFC device depicted in FIG. 8;

FIG. 18 is a block diagram illustrating still another example of the NFC device depicted in FIG. 8;

FIG. 19 is a block diagram illustrating still another example of the NFC device depicted in FIG. 8; and

FIG. 20 is a block diagram illustrating an electronic system according to some example embodiments.

### DETAILED DESCRIPTION

Example embodiments will now be described more fully with reference to the accompanying drawings. Embodiments, however, may be embodied in many different forms and should not be construed as being limited to the embodiments set forth herein. Rather, these example embodiments are provided so that this disclosure will be thorough and complete, and will fully convey the scope to those skilled in the art. In the drawings, the thicknesses of layers and regions may be exaggerated for clarity.

It will be understood that when an element is referred to as being “on,” “connected to,” “electrically connected to,” or “coupled to” to another component, it may be directly on, connected to, electrically connected to, or coupled to the other component or intervening components may be present. In contrast, when a component is referred to as being “directly on,” “directly connected to,” “directly electrically connected to,” or “directly coupled to” another component, there are no intervening components present. As used herein, the term “and/or” includes any and all combinations of one or more of the associated listed items.

It will be understood that although the terms first, second, third, etc., may be used herein to describe various elements, components, regions, layers, and/or sections, these elements, components, regions, layers, and/or sections should not be limited by these terms. These terms are only used to distinguish one element, component, region, layer, and/or section from another element, component, region, layer, and/or section. For example, a first element, component, region, layer, and/or section could be termed a second element, component, region, layer, and/or section without departing from the teachings of example embodiments.

Spatially relative terms, such as “beneath,” “below,” “lower,” “above,” “upper,” and the like may be used herein for ease of description to describe the relationship of one component and/or feature to another component and/or feature, or other component(s) and/or feature(s), as illustrated in the drawings. It will be understood that the spatially relative terms are intended to encompass different orientations of the device in use or operation in addition to the orientation depicted in the figures.

The terminology used herein is for the purpose of describing particular example embodiments only and is not intended to be limiting of example embodiments. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

Example embodiments may be described herein with reference to cross-sectional illustrations that are schematic illustrations of idealized example embodiments (and intermediate structures). As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle will typically have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature, their shapes are not intended to illustrate the actual shape of a region of a device, and their shapes are not intended to limit the scope of the example embodiments.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and should not be interpreted in an idealized or overly formal sense unless expressly so defined herein.

Reference will now be made to example embodiments, which are illustrated in the accompanying drawings, wherein like reference numerals may refer to like components throughout.

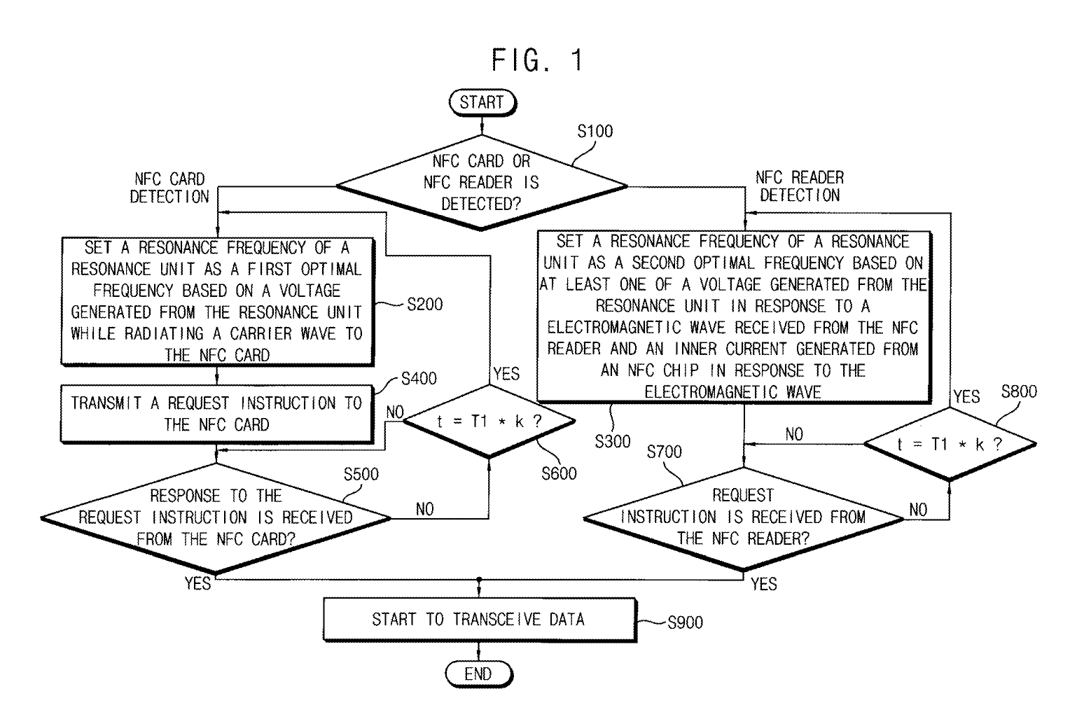

FIG. 1 is a flowchart illustrating a method of controlling a resonance frequency of a Near Field Communication (NFC) device according to some example embodiments.

The NFC device includes a resonance unit for transceiving data through an electromagnetic wave and an NFC chip for providing output data to the resonance unit and receiving input data from the resonance unit. The resonance unit includes a resonance circuit which includes an antenna having an inductance component and a resonance capacitor. The resonance frequency of the resonance circuit is determined based on an inductance of the antenna and a capacitance of the resonance capacitor. The NFC device performs communication by matching the resonance frequency to that of an external NFC device.

For example, the NFC device may transceive data with an external NFC reader based on an electromagnetic wave provided from the external NFC reader in a card mode in which the NFC device is operated as a card, and may transceive data with an external NFC card based on an electromagnetic wave generated from the NFC device in a reader mode in which the NFC device is operated as a reader.

Referring to FIG. 1, in the method of controlling a resonance frequency of an NFC device according to some example embodiments, it is detected in step S100 whether an NFC card or an NFC reader exists around.

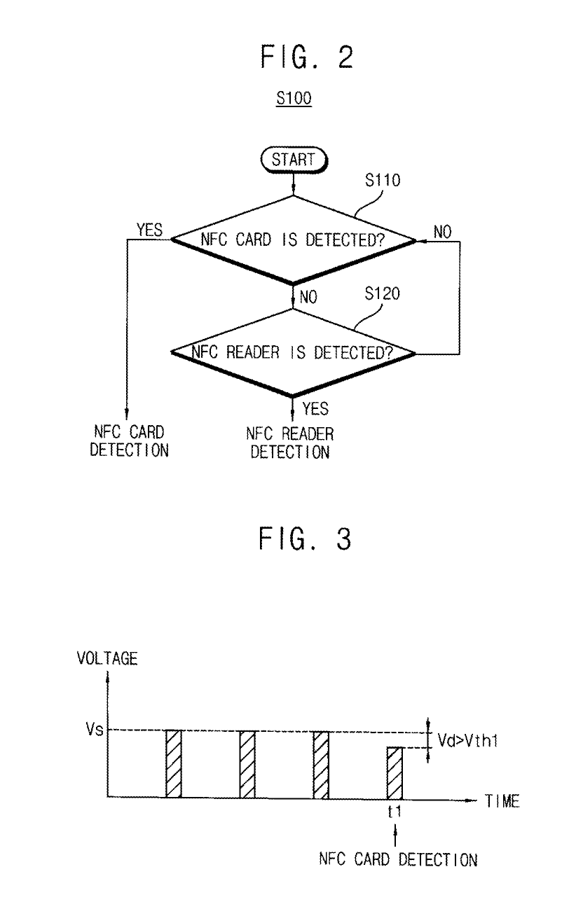

FIG. 2 is a flowchart illustrating one example of step S100 of detecting whether the NFC card or the NFC reader exists around.

Referring to FIG. 2, if the NFC device is turned on, until the NFC card or the NFC reader is detected, step S110 of detecting the NFC card and step S120 of detecting the NFC reader may be performed alternately and repeatedly.

According to some example embodiments, in order to detect whether the NFC card exists around, a carrier wave having a standard voltage is periodically radiated through the resonance unit. While the carrier wave is being radiated, when a voltage generated from the resonance unit is lower than the standard voltage by a first threshold voltage or more, it may be determined that the NFC card is detected.

FIG. 3 is a view illustrating step S110 of detecting an NFC card.

In FIG. 3, a transverse axis represents a time and a longitudinal axis represents a voltage generated from the resonance unit.

As shown in FIG. 3, the NFC device may radiate a carrier wave having a standard voltage Vs through the resonance unit in order to search for the NFC card.

When the NFC card does not exist around the NFC device, the carrier wave radiated through the resonance unit is not returned because the carrier wave is not reflected from the NFC card, so a voltage of the resonance unit may be substantially maintained at the standard voltage Vs.

Meanwhile, when a NFC card approaches near the NFC device at time t1, since the carrier wave radiated through the resonance unit reflects upon and returns from the NFC card, the voltage of the resonance unit may be reduced to be less than the standard voltage Vs.

Thus, the carrier wave having the standard voltage Vs is periodically radiated through the resonance unit. While radiating the carrier wave, a voltage generated from the resonance unit is measured. When a voltage difference Vd between the measured voltage and the standard voltage Vs is equal to or greater than a first threshold voltage Vth1, it may be determined that the NFC card is detected.

According to some example embodiments, in order to detect whether an NFC reader exists near, a voltage generated from the resonance unit is periodically measured in response to an electromagnetic wave received from an outside. When the measured voltage is equal to or greater than a second threshold voltage, it may be determined that the NFC reader is detected.

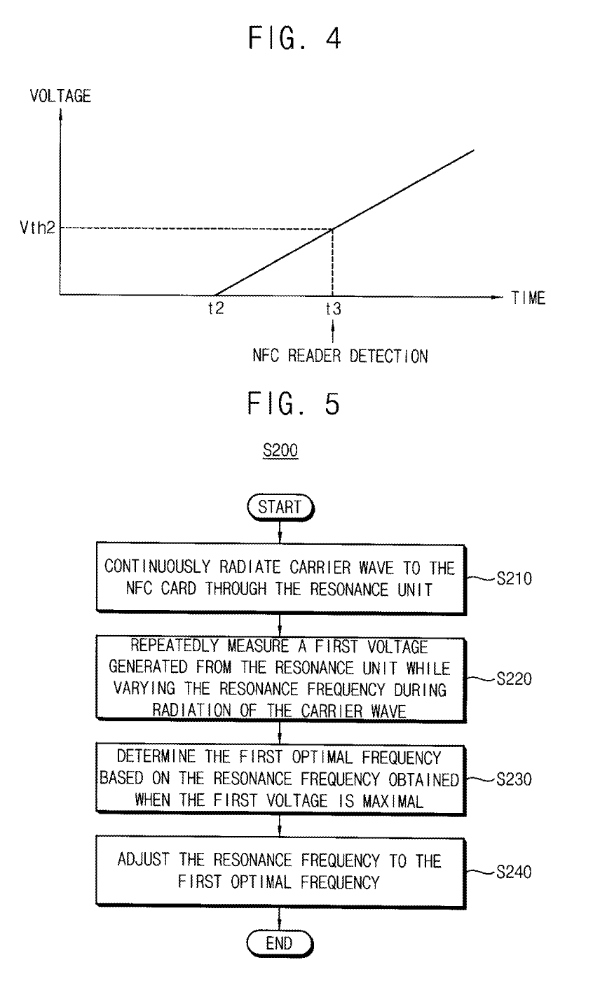

FIG. 4 is a view illustrating step S120 of detecting an NFC reader of FIG. 2.

In FIG. 4, a transverse axis represents a time and a longitudinal axis represents a voltage generated from the resonance unit.

As shown in FIG. 4, when any NFC readers do not exist near the NFC device, since any electromagnetic waves received from an outside do not exist, a voltage induced to the resonance unit may substantially be zero.

As the NFC device approaching an NFC reader starts to receive a carrier wave radiated from the NFC reader at time t2, an induced voltage may be generated from the resonance unit at time t2.

As the NFC device approaches the NFC reader, the induced voltage generated from the resonance unit may be increased more and more.

When the NFC device approaches within a desired distance (that may or may not be predetermined) from the NFC reader at time t3, the voltage induced to the resonance unit may be increased to the level of the second threshold voltage Vth2 or more.

Thus, when the voltage generated from the resonance unit in response to the electromagnetic wave received from an outside is equal to or greater than the second threshold voltage Vth2, it may be determined that the NFC reader is detected.

Referring to FIG. 1 again, when the NFC card is detected, the carrier wave is continuously radiated through the resonance unit to the NFC card. In step S200, while radiating the carrier wave, a resonance frequency of the resonance unit is set as a first optimal frequency (or first frequency with improved performance) based on the magnitude of a voltage generated from the resonance unit.

FIG. 5 is a flowchart illustrating one example of step S200 of setting a resonance frequency of the resonance unit as the first optimal frequency (or first frequency with improved performance) when the NFC card is detected in FIG. 1.

When the NFC card is detected, the NFC device may be operated in a reader mode.

Referring to FIG. 5, when the NFC card is detected, the carrier wave is continuously radiated to the NFC card in step S210. While the carrier wave is being radiated, a first voltage generated from the resonance unit may be repeatedly measured while varying a resonance frequency of the resonance unit in step S220.

In some example embodiments, a capacitive load may be connected to the resonance unit and the resonance frequency of the resonance unit may be changed by changing a capacitance of the capacitive load. For example, capacitance of the capacitive load may be sequentially increased while the carrier wave is being radiated, and the first voltage generated from the resonance unit may be measured with respect to each capacitance of the capacitive load.

In some example embodiments, the capacitive load may be connected between a terminal, through which the resonance unit outputs the first voltage, and a ground voltage. In some example embodiments, the capacitive load may be connected between a terminal, through which the resonance unit receives the carrier signal corresponding to the carrier wave from the NFC chip, and the ground voltage.

In order to measure the first voltage, a count value, which is sequentially increased by performing an up-counting operation, may be generated and a scanning voltage, which is sequentially increased based on the count value, may be generated. By comparing the magnitude of the first voltage with the magnitude of the scanning voltage, the count value at a time point when the magnitude of the scanning voltage is equal to or greater than the magnitude of the first voltage may be generated as a digital value. Thus, the digital value may represent the magnitude of the first voltage. Meanwhile, an accuracy of converting the magnitude of the first voltage into the digital value may be controlled by adjusting an increasing rate of the scanning voltage which is sequentially increased based on the count value.

Then, in step S230, the first optimal frequency (or first frequency with improved performance) is determined based on the resonance frequency when the first voltage is the maximum voltage of the measured voltages. In step S240, the resonance frequency of the resonance unit may be adjusted to the first optimal frequency (or first frequency with improved performance).

In some example embodiments, by comparing the digital values generated according to each capacitance of the capacitive load with each other, the capacitance of the capacitive load may be determined as a first optimal capacitance (or first capacitance with improved performance) when the digital value is maximized, and then, the capacitance of the capacitive load may be set as the first optimal capacitance (or first capacitance with improved performance). In this case, the resonance frequency of the resonance unit may be substantially equal to the carrier frequency included in the carrier wave generated from the NFC device. Thus, since the maximum voltage is generated from the resonance unit, the operation performance of the NFC device may be maximized in the reader mode.

In some example embodiments, by comparing the digital values generated according to each capacitance of the capacitive load with each other, a value, that is obtained by adding a first offset capacitance to the capacitance of the capacitive load, may be determined as the first optimal capacitance (or first capacitance with improved performance) when the digital value is maximized, and then, the capacitance of the capacitive load may be set as the first optimal capacitance (or first capacitance with improved performance). The first offset capacitance may have a desired value (that may or may not be predetermined) according to a characteristic of the NFC chip. In this case, the resonance frequency of the resonance unit may differ from the carrier frequency included in the carrier wave generated from the NFC device by the first offset frequency corresponding to the first offset capacitance. When the maximum voltage is generated in the resonance unit, a noise component may be also increased. Thus, in the reader mode, the operation performance of the NFC device may be optimized by setting the resonance frequency of the resonance unit such that the resonance frequency may differ from the carrier frequency by the first offset frequency according to the noise removal characteristic of the NFC device.

Meanwhile, according to external environment such as temperature or humidity and operation environment such as a distance between the NFC device and the NFC card, the resonance frequency may vary. Therefore, the resonance frequency may be periodically tuned to the first optimal frequency (or first frequency with improved performance).

For example, referring to FIG. 1, the NFC card is detected in step S100 and the resonance frequency of the resonance unit is set as the first optimal frequency (or first frequency with improved performance) in step S200. Then, a request instruction is transmitted to the NFC card in step S400 and it may wait for a first time T1 in steps S500 and S600 to receive response to the request instruction. When the response to the request instruction is received from the NFC card for the first time T1, the NFC device may start to transceive data with the NFC card in step S900. To the contrary, when the response to the request instruction is not received from the NFC card for the first time T1, the NFC device may repeatedly perform the operation of step S200 of setting the resonance frequency as the first optimal frequency (or first frequency with improved performance) using, for example, counter ‘k’.

Even though the resonance frequency varies according external environment and operation environment, the resonance frequency is periodically tuned to the first optimal frequency (or first frequency with improved performance) so that the operation performance of the NFC device may be improved.

Referring to FIG. 1 again, in step S300, when the NFC reader is detected, the resonance frequency is set as a second optimal frequency (or second frequency with improved performance) based on at least one of the amounts of inner currents generated from the NFC chip in response to an electromagnetic wave received from the NFC reader and a magnitude of a voltage generated from the resonance unit in response to an electromagnetic wave received from the NFC reader.

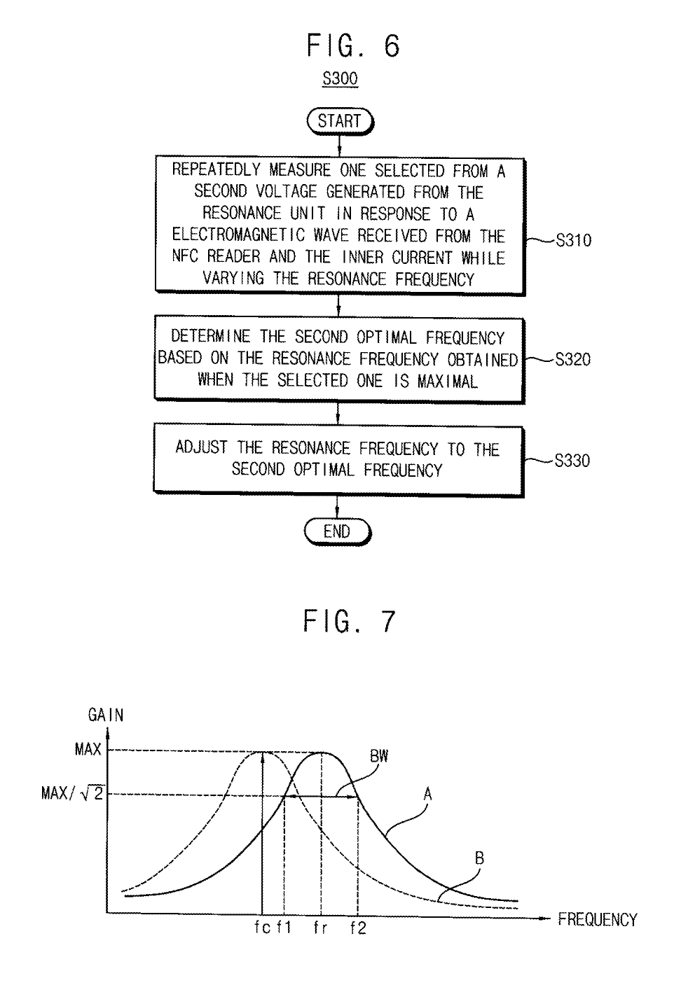

FIG. 6 is a flowchart illustrating one example of step S300 of setting a resonance frequency of the resonance unit as the second optimal frequency (or second frequency with improved performance) when an NFC reader is detected in FIG. 1.

When the NFC reader is detected, the NFC device may be operated in a card mode.

Referring to FIG. 6, when the NFC reader is detected, while the resonance frequency is varying, the NFC device may repeatedly measure a second voltage generated from the resonance unit and one selected from the inner currents in response to an electromagnetic wave received from the NFC reader in step S310. For example, when the electromagnetic wave is relatively weak, the NFC device may repeatedly measure the second voltage. To the contrary, when the electromagnetic wave is relatively strong, the NFC device may repeatedly measure the inner current. The terminal, through which the resonance unit outputs the first voltage in the reader mode, may be the same as that through which the second voltage is output in the card mode.

In some example embodiments, the capacitive load may be connected to the resonance unit and the resonance frequency of the resonance unit may be changed by changing a capacitance of the capacitive load. For example, the inner current, which is generated from the NFC chip in response to the electromagnetic wave received from the NFC reader, or the second voltage, which is generated from the resonance unit in response to the electromagnetic wave received from the NFC reader, can be measured with respect to each capacitance of the capacitive load while sequentially increasing the capacitance of the capacitive load.

In some example embodiments, the capacitive load may be connected between the terminal, through which the resonance unit outputs the second voltage, and a ground voltage. In some example embodiments, the capacitive load may be connected between a terminal, through which the resonance unit receives the carrier signal corresponding to the carrier wave from the NFC chip, and the ground voltage.

In order to measure the second voltage or the inner current, a count value, which is sequentially increased by performing an up-counting operation, may be generated and a scanning voltage, which is sequentially increased based on the count value, may be generated. The inner current is converted into a direct current voltage. Either the second voltage or the direct current voltage is selected. Then, by comparing the magnitude of the selected voltage with the magnitude of the scanning voltage, the count value at a time point when the magnitude of the scanning voltage is equal to or greater than the magnitude of the first voltage may be generated as a digital value. Thus, the digital value may represent the magnitude of the selected voltage. Meanwhile, an accuracy of converting the magnitude of the scanning voltage into the digital value may be controlled by adjusting an increasing rate of the scanning voltage which is sequentially increased based on the count value.

Then, in step S320, the second optimal frequency (or second frequency with improved performance) is determined based on the resonance frequency when the selected voltage is the maximum voltage of the measured voltages. In step S330, the resonance frequency of the resonance unit may be adjusted to the second optimal frequency (or second frequency with improved performance).

In some example embodiments, by comparing the digital values generated according to each capacitance of the capacitive load with each other, the capacitance of the capacitive load may be determined as a second optimal capacitance (or second capacitance with improved performance) when the digital value is maximized, and then, the capacitance of the capacitive load may be set as the second optimal capacitance (or second capacitance with improved performance). In this case, the resonance frequency of the resonance unit may be substantially equal to the carrier frequency included in the carrier wave received from the NFC reader. Thus, since the maximum voltage is generated from the resonance unit, the operation performance of the NFC device may be maximized in the card mode.

In some example embodiments, by comparing the digital values generated according to each capacitance of the capacitive load with each other, a value, that is obtained by adding a second offset capacitance to the capacitance of the capacitive load, may be determined as the second optimal capacitance (or second capacitance with improved performance) when the digital value is maximized, and then, the capacitance of the capacitive load may be set as the second optimal capacitance (or second capacitance with improved performance). The second offset capacitance may have a desired value (that may or may not be predetermined) according to the characteristic of the NFC chip. In this case, a difference between the resonance frequency of the resonance unit and the carrier frequency included in the carrier wave may exist by the second offset frequency corresponding to the second offset capacitance. When the maximum voltage is generated in the resonance unit, a noise component may be also increased. Thus, in the reader mode, the operation performance of the NFC device may be optimized by setting the resonance frequency of the resonance unit differently from the carrier frequency by the second offset frequency according to a noise removal characteristic of the NFC device.

Meanwhile, according to external environment such as temperature or humidity and operation environment such as a distance between the NFC device and the NFC reader, the resonance frequency may vary. Therefore, the resonance frequency may be periodically tuned to the second optimal frequency (or second frequency with improved performance).

For example, referring to FIG. 1, the NFC reader is detected in step S100 and the resonance frequency of the resonance unit is set as the second optimal frequency (or second frequency with improved performance) in step S300. The NFC device may wait for the first time T1 to receive a request instruction from the NFC reader in steps S700 and S800. When the request instruction is received from the NFC reader for the first time T1, the NFC device may start to transceive data with the NFC reader in step S900. To the contrary, when the request instruction is not received from the NFC reader for the first time T1, the NFC device may repeatedly perform the operation of step S300 of setting the resonance frequency as the second optimal frequency (or second frequency with improved performance).

Even though the resonance frequency varies according external environment and operation environment, the resonance frequency is periodically tuned to the second optimal frequency (or second frequency with improved performance) so that the operation performance of the NFC device may be improved.

FIG. 7 is a graph illustrating an effect of the method of controlling a resonance frequency of the NFC device of FIG. 1.

In FIG. 7, a first graph A shows a frequency characteristic of the resonance unit before applying the method of controlling a resonance frequency of an NFC device according to some example embodiments depicted in FIG. 1, and a second graph B shows a frequency characteristic of the resonance unit after applying the method of controlling a resonance frequency of an NFC device according to some example embodiments depicted in FIG. 1.

Referring to the first graph A, the resonance unit may have a frequency characteristic of a bell shape having a resonance frequency fr as a center frequency. The resonance unit may have a maximum gain MAX at the resonance frequency fr, and may have a bandwidth BW and first and second frequencies f1 and f2 as cutoff frequencies.

When the resonance frequency fr is different from the carrier frequency fc included in the carrier wave, the voltage generated from the resonance unit may be reduced. Specifically, as shown in FIG. 7, when the carrier frequency fc is out of the bandwidth BW of the resonance unit, the carrier wave is filtered in the resonance unit so that communication cannot be performed.

In a case of a general NFC device, due to a difference between elements used in the reader and card modes, the resonance frequencies in the reader and card modes are set to be different from each other. Thus, when the resonance frequency in the reader mode is caused to be equal to the carrier frequency, the resonance frequency in the card mode is different from the carrier frequency. In addition, when the resonance frequency in the card mode is caused to be equal to the carrier frequency, the resonance frequency in the reader mode is different from the carrier frequency.

However, according to the method of controlling a resonance frequency of an NFC device depicted in FIG. 1, the voltage generated from the resonance unit is measured while varying the resonance frequencies fr in the reader and card modes. Then, a resonance frequency, at which the measured voltage is maximized, may be set as the resonance frequency fr of the resonance unit. Otherwise, a frequency, which is obtained by adding an offset frequency to a resonance frequency, at which the measured voltage is maximized, may be set as the resonance frequency fr of the resonance unit according to a noise removal characteristic of the NFC device. Thus, the frequency characteristic of the resonance unit is changed as the second graph B in each of the reader and card modes so that the carrier frequency fc exists in the bandwidth BW of the resonance unit.

According to the method of controlling a resonance frequency of an NFC device depicted in FIG. 1, since the resonance frequency may be independently set in the reader mode and the card mode, even when the optimal resonance frequency (or frequency with improved performance) required in the reader mode is different from the optimal resonance frequency (or frequency with improved performance) required in the card mode, the resonance frequency may be set at the optimal frequency (or frequency with improved performance) required for each mode.

Further, even when the resonance frequency varies according to variables of external environment and operation environment, the resonance frequency is periodically tuned to maintain the magnitude of the voltage generated from the resonance unit at a desired level (that may or may not be predetermined) or more, so that the operation performance of the NFC device may be more improved.

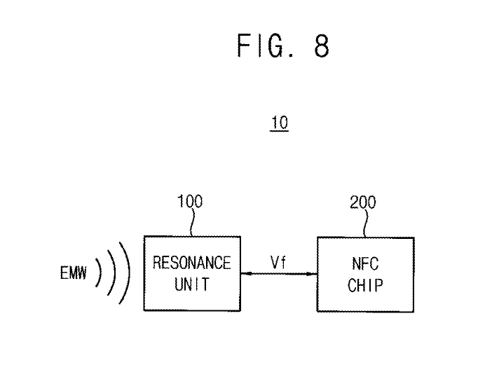

FIG. 8 is a block diagram illustrating an NFC device according to some example embodiments.

The method of controlling a resonance frequency of the NFC device described above with reference to FIGS. 1 to 7 may be performed through the NFC device of FIG. 8.

The NFC device 10 depicted in FIG. 8 performs communication with an external device based on an NFC scheme. In the card mode in which the NFC device 10 is operated as a card, the NFC device 10 may transceive data with an external NFC reader based on an Electromagnetic Wave (EMW) provided from an NFC reader. In the reader mode in which the NFC device 10 is operated as a reader, the NFC device 10 may transceive data with an external NFC card based on an EMW provided from the NFC device 10.

Referring to FIG. 8, the NFC device 10 includes a resonance unit 100 and an NFC chip 200.

The resonance unit 100 includes an antenna having an inductance component and a resonance capacitor and generates a field voltage Vf in response to an electromagnetic wave.

The NFC chip 200 detects whether an NFC card or an NFC reader exists around the NFC chip 200 based on a magnitude of the field voltage Vf. When the NFC chip 200 detects an NFC card, the NFC chip 200 sets a resonance frequency of the resonance unit 100 as the first optimal frequency (or first frequency with improved performance) based on the field voltage Vf and is operated in the reader mode. When an NFC reader is detected, the NFC chip 200 sets the resonance frequency of the resonance unit 100 as the second optimal frequency (or second frequency with improved performance) based on at least one of inner currents generated in response to the magnitude of the field voltage Vf and the electromagnetic wave and is operated in the card mode.

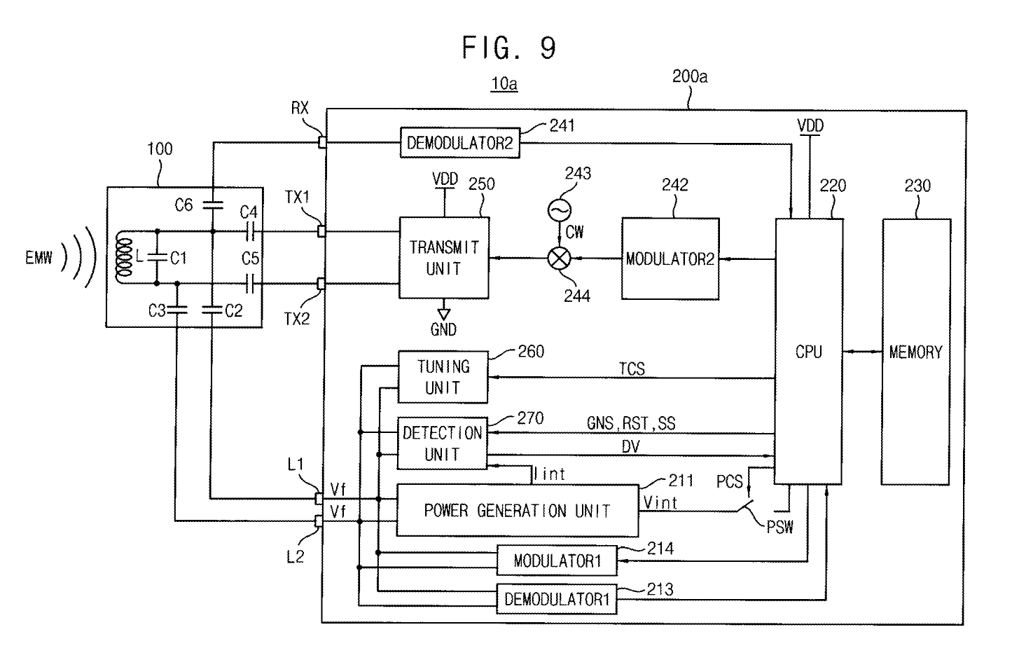

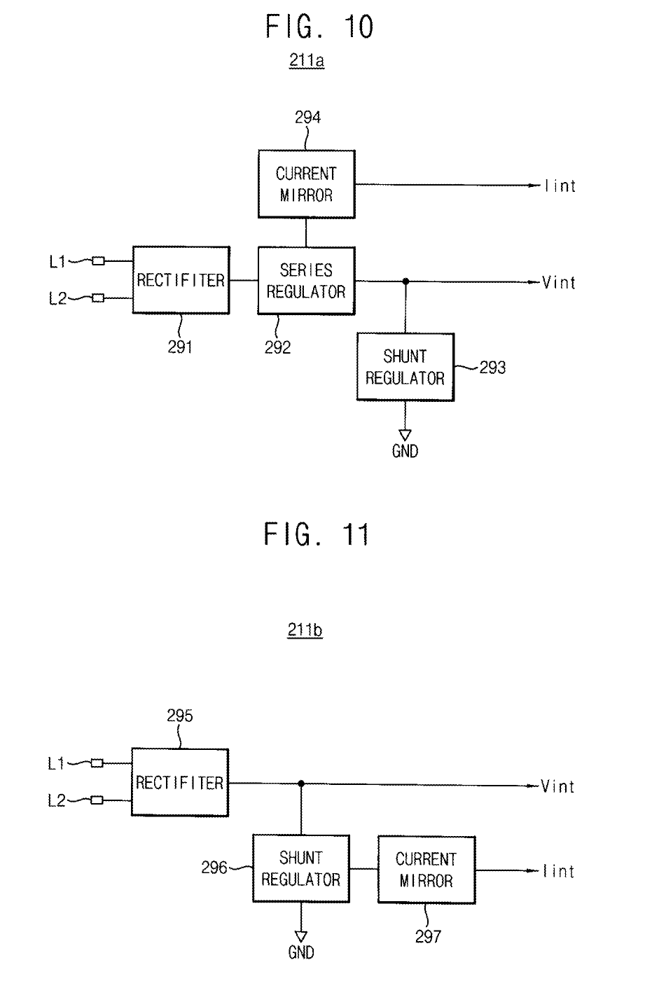

FIG. 9 is a block diagram illustrating one example of the NFC device depicted in FIG. 8.

Referring to FIG. 9, an NFC device 10a may include a resonance unit 100 and an NFC chip 200a.

The NFC chip 200a may be connected to the resonance unit 100 through first and second power terminals L1 and L2, first and second transmit terminals TX1 and TX2, and a reception terminal RX.

The resonance unit 100 may include a resonance circuit including an antenna L and a first capacitor C1, a first filter including second and third capacitors C2 and C3 through which the resonance circuit is connected to the first and second power terminals L1 and L2, a second filter including a sixth capacitor C6 through which the resonance circuit is connected to the reception terminal RX, and a matching unit including fourth and fifth capacitors C4 and C5 which the resonance circuit is connected to the first and second transmit terminals TX1 and TX2 through and perform an impedance matching.

The configuration of the resonance unit 100 depicted in FIG. 9 may be an example only, and the configuration of the resonance unit 100 according to some example embodiments may not be limited to the above, but may be variously modified.

The NFC chip 200a may perform transmit and reception operations through the first and second power terminals L1 and L2 in the card mode, and may perform a transmission operation through the first and second transmit terminals TX1 and TX2 and a reception operation through the reception terminal RX in the reader mode.

The NFC chip 200a included in the NFC device 10a according to some example embodiments (e.g., FIG. 9) may receive a field voltage Vf from the resonance unit 100 through the first and second power terminals L1 and L2.

The NFC chip 200a may include a power generation unit 211, first and second demodulators 213 and 241, first and second modulators 214 and 242, a Central Processing Unit (CPU) 220, a power switch PSW, a memory 230, an oscillator 243, a mixer 244, a transmit unit 250, a tuning unit 260, and a detection unit 270.

The power generation unit 211 may generate an inner current lint and an inner voltage Vint having a desired voltage level (that may or may not be predetermined) using a voltage provided through the first and second power terminals L1 and L2 from the resonance unit 100.

FIG. 10 is a block diagram illustrating one example of the power generation unit included in the NFC device of FIG. 9.

Referring to FIG. 10, the power generation unit 211a may include a rectifier 291, a series regulator 292, a shunt regulator 293, and a current mirror 294.

The rectifier 291 may generate a rectified voltage by rectifying the voltage provided from the resonance unit 100 through the first and second power terminals L1 and L2. The series regulator 292 may be connected to an output terminal of the rectifier 291 and the shunt regulator 293 may be connected between an output terminal of the series regulator 292 and a ground voltage GND. Thus, the series and shunt regulators 292 and 293 may generate the inner voltage Vint having the desired voltage level Vint (that may or may not be predetermined) which is usable in the NFC chip 200a through the output terminal of the series regulator 292 by using the rectified voltage.

The current mirror 294 may generate the inner current lint having an intensity which is proportional to that of a current flowing through the series regulator 292.

FIG. 11 is a block diagram illustrating another example of the power generation unit included in the NFC device of FIG. 9.

Referring to FIG. 11, the power generation unit 211b may include a rectifier 295, a shunt regulator 296, and a current mirror 297.

The rectifier 295 may generate a rectified voltage by rectifying a voltage provided through the first and second power terminals L1 and L2 from the resonance unit 100. The shunt regulator 296 may be connected between an output terminal of the rectifier 295 and a ground voltage GND. Thus, the shunt regulator 296 may generate the inner voltage Vint having a desired voltage level (that may or may not be predetermined) which is usable in the NFC chip 200a through an output terminal of the rectifier 295 by using the rectified voltage.

The current mirror 297 may generate the inner current lint having an intensity which is proportional to that of a current flowing through the shunt regulator 296.

The CPU 220 may control overall operations of the NFC chip 200. The CPU 220 may be operated by receiving a power source voltage VDD from a power source unit such as a battery. Further, the CPU 220 may receive the inner voltage Vint through the power switch PSW from the power generation unit 211. When the power source voltage VDD has a desired level (that may or may not be predetermined) or above, the CPU 220 may be operated using the power source voltage VDD and may allow a power control signal PCS to be disable such that the power switch PSW may be turned off. Meanwhile, when the power source voltage VDD has the desired level (that may or may not be predetermined) or below, the CPU 220 allows the power control signal PCS to be enable such that the power switch PSW is turned on, so the CPU 220 may be operated by using the inner voltage Vint provided from the power generation unit 211.

When a reception operation is performed in the card mode, the first demodulator 213 may demodulate a signal provided through the first and second power terminals L1 and L2 from the resonance unit 100 to generate input data and may provide the input data to the CPU 220. The CPU 220 may store the input data in the memory 230.

When a transmission operation is performed in the card mode, the CPU 220 may read out output data from the memory 230 to provide the output data to the first modulator 214. The first modulator 214 may modulate the output data to provide a modulated signal to the first and second power terminals L1 and L2. For example, the first modulator 214 may perform a load modulation for the output data to generate the modulated signal.

When a reception operation is performed in the reader mode, the second demodulator 241 may demodulate a signal provided through the reception terminal RX from the resonance unit 100 to generate input data and may provide the input data to the CPU 220. The CPU 220 may store the input data in the memory 230.

When a transmission operation is performed in the reader mode, the CPU 220 may read out output data from the memory 230 to provide the output data to the second modulator 242. The second modulator 242 may modulate the output data to generate a modulated signal. In addition, the oscillator 243 may generate a carrier signal CW having a frequency corresponding to a carrier frequency (for example, 13.56 MHz), and the mixer 244 may combine the carrier signal CW with the modulated signal to generate a transmission signal.

In the reader mode, the transmit unit 250 may provide the transmission signal provided from the mixer 244 to the resonance unit 100 through the first and second transmit terminals TX1 and TX2, and the resonance unit 100 may radiate an electromagnetic wave EMW corresponding to the transmission signal. For example, the transmit unit 250 is connected between the power source voltage VDD and the ground voltage GND. In the reader mode, the transmit unit 250 may allow the first and second transmit terminals TX1 and TX2 to be connected to either the power source voltage VDD through a pull-up load or the ground voltage GND through pull-down load based on the transmission signal, so that the transmission signal may be provided to the resonance unit 100 through the first and second transmit terminals TX1 and TX2.

Meanwhile, during a section of detecting whether an NFC card exists around and a section where the output data are not transmitted in the reader mode, since the CPU 220 does not provide the output data to the second modulator 242, the transmission signal provided by the transmit unit 250 through the first and second transmit terminals TX1 and TX2 may be substantially identical to the carrier signal CW.

The tuning unit 260 may connect a capacitive load, which has a capacitance corresponding to a tuning control signal TCS provided from the CPU 220, to the resonance unit 100 through the first and second power terminals L1 and L2.

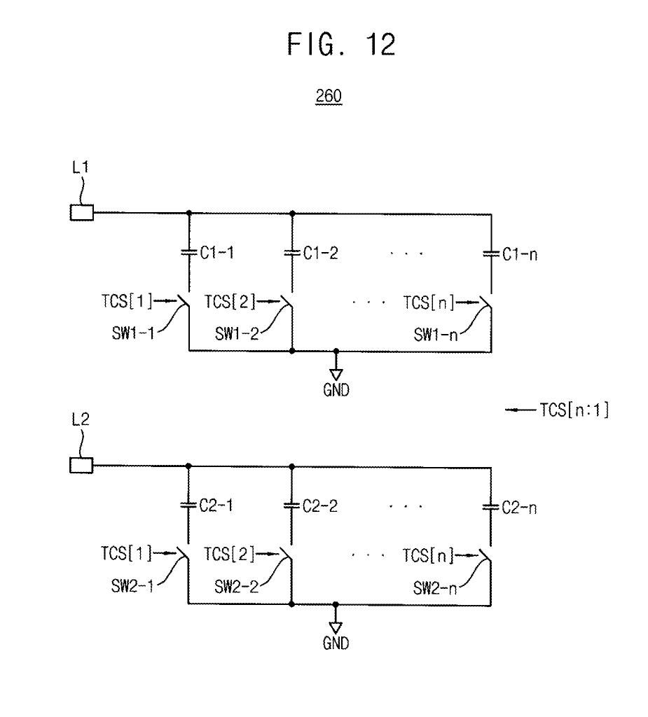

FIG. 12 is a block diagram illustrating one example of the tuning unit included in the NFC device of FIG. 9.

Referring to FIG. 12, the tuning unit 260 may include (1-1)TH to (1-n)TH capacitors C1-1, C1-2, . . . , and C1-n, (1-1)TH to (1-n)TH switches SW1-1, SW1-2, . . . , and SW1-n, (2-1)TH to (2-n)TH capacitors C2-1, C2-2, . . . , and C2-n, and (2-1)TH to (2-n)TH switches SW2-1, SW2-2, . . . , and SW2-n, wherein ‘n’ is an integer of 2 or more.

The (1-1)TH to (1-n)TH switches SW1-1, SW1-2, . . . , and SW1-n may be connected in series to the (1-1)TH to (1-n)TH capacitors C1-1, C1-2, . . . , and C1-n, respectively. The (2-1)TH to (2-n)TH switches SW2-1, SW2-2, . . . , and SW2-n may be connected in series to the (2-1)TH to (2-n)TH capacitors C2-1, C2-2, . . . , and C2-n, respectively. The (1-1)TH to (1-n)TH capacitors C1-1, C1-2, . . . , and C1-n and the (1-1)TH to (1-n)TH switches SW1-1, SW1-2, . . . , and SW1-n may be connected in parallel between the first power terminal L1 and the ground voltage GND. The (2-1)TH to (2-n)TH capacitors C2-1, C2-2, . . . , and C2-n and the (2-1)TH to (2-n)TH switches SW2-1, SW2-2, . . . , and SW2-n may be connected in parallel between the second power terminal L2 and the ground voltage GND.

The tuning control signal TCS provided from the CPU 220 may be an n-bit signal. Each bit included in the tuning control signal TCS may control the (1-1)TH to (1-n)TH switches SW1-1, SW1-2, . . . , and SW1-n and the (2-1)TH to (2-n)TH switches SW2-1, SW2-2, . . . , and SW2-n. For example, a first bit TSC[1] of the tuning control signal TCS may control the (1-1)TH switch SW1-1 and the (2-1)TH switch SW2-1. The second bit TSC[2] of the tuning control signal TCS may control the (1-2)TH switch SW1-2 and the (2-2)TH switch SW2-2. The nTH bit TSC[n] of the tuning control signal TCS may control the (1-n)TH switch SW1-n and the (2-n)TH switch SW2-n.

As described above, since the capacitances of the capacitive loads of the tuning unit 260, which are connected between the first power terminal L1 and the ground voltage GND and between the second power terminal L2 and the ground voltage GND, are determined based on the tuning control signal TCS, the resonance frequency of the resonance unit 100 may vary by varying the tuning control signal TCS.

Referring FIG. 9 again, the detection unit 270 is connected to the first and second power terminals L1 and L2. The detection unit 270 may convert one of the inner current lint provided from the power generation unit 211 and the field voltage Vf received through the first and second power terminals L1 and L2 into a digital value DV based on control signals provided from the CPU 220, and may provide the digital value DV to the CPU 220.

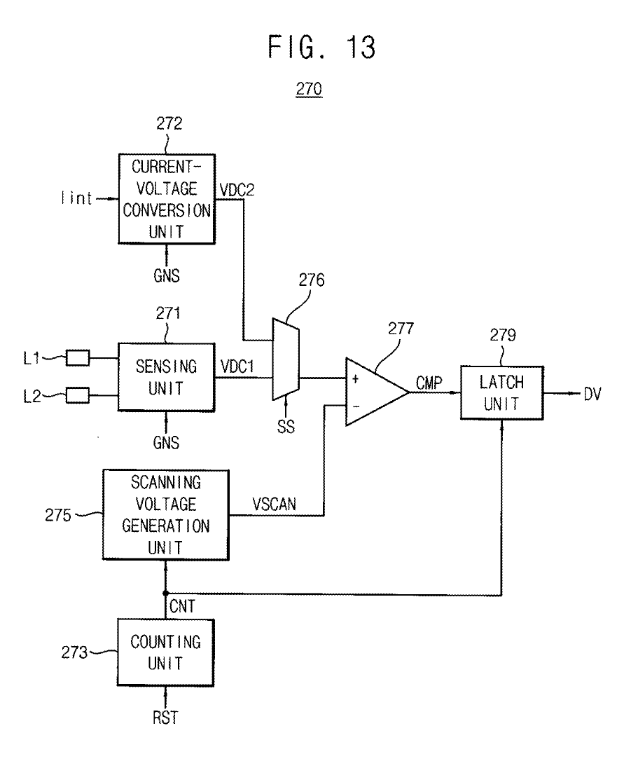

FIG. 13 is a block diagram illustrating one example of the detection unit included in the NFC device of FIG. 9.

Referring to FIG. 13, the detection unit 270 may include a sensing unit 271, a current-voltage conversion unit 272, a counting unit 273, a scanning voltage generation unit 275, a multiplexer 276, a comparator 277, and a latch unit 279.

The sensing unit 271 may convert the field voltage provided through the first and second power terminals L1 and L2 into a first DC voltage VDC1. For example, the sensing unit 271 may generate the first direct current (DC) voltage VDC1 which is proportional to a magnitude of the field voltage Vf and a gain signal GNS provided from the CPU 220.

During a section of detecting whether an NFC card exists around and in the reader mode, the transmit unit 250 provides the transmission signal including the carrier signal CW to the resonance unit 100 through first and second transmit terminals TX1 and TX2. To the contrary, during a section of detecting whether an NFC reader exists around and in the card mode, the transmit unit 250 does not generate the transmission signal. Thus, the magnitude of the field voltage Vf provided to the sensing unit 271 during a section of detecting whether an NFC card exists around and in the reader mode may be relatively greater than that of the field voltage Vf provided to the sensing unit 271 during a section of detecting whether an NFC reader exists around and in the card mode. Therefore, the CPU 220 provides the gain signal GNS having a first value to the sensing unit 271 during a section of detecting whether an NFC card exists around and in the reader mode and provides the gain signal GNS having a second value greater than the first value to the sensing unit 271 during a section of detecting whether an NFC reader exists around and in the card mode, so that the sensing unit 271 may generate the first DC voltage VDC1 having a magnitude in a desired range (that may or may not be predetermined) regardless of the operation modes.

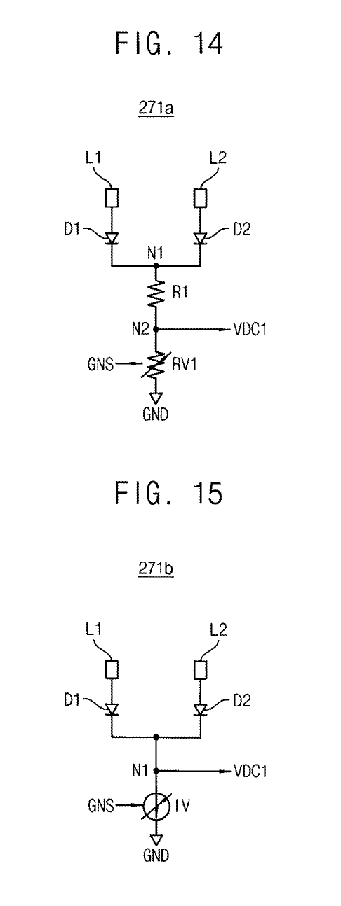

FIG. 14 is a block diagram illustrating one example of the sensing unit included in the detection unit of FIG. 13.

Referring to FIG. 14, the sensing unit 271a may include a rectifier circuit including first and second diodes D1 and D2, a first resistor R1, and a first variable resistor RV1.

The first diode D1 may be connected between the first power terminal L1 and a first node N1. The second diode D2 may be connected between the second power terminal L2 and the first node N1. Thus, the rectifier circuit may rectify the field voltage Vf to output a rectified voltage to the first node N1.

The first resistor R1 may be connected between the first node N1 and a second node N2, and the first variable resistor RV1 may be connected between the second node N2 and the ground voltage GND. The first variable resistor RV1 may have a resistance value having a magnitude corresponding to the gain signal GNS.

Since the first resistor R1 and the first variable resistor RV1 are operated as a voltage dividing circuit for dividing the rectified voltage, the sensing unit 271a may convert the field voltage Vf into the first DC voltage VDC1 based on the gain signal GNS and may output the first DC voltage VDC1 through the second node N2.

FIG. 15 is a block diagram illustrating another example of the sensing unit included in the detection unit of FIG. 13.

Referring to FIG. 15, a sensing unit 271b may include a rectifier circuit including first and second diodes D1 and D2, and a variable current source IV.

The first diode D1 may be connected between the first power terminal L1 and a first node N1 and the second diode D2 may be connected between the second power terminal L2 and the first node N1. Thus, the rectifier circuit may rectify the field voltage Vf to output a rectified voltage to the first node N1.

The variable current source IV may be connected between the first node N1 and the ground voltage GND. The variable current source IV may generate a current having an intensity corresponding to the gain signal GNS.

Since a magnitude of the rectified voltage may vary according to an intensity of the current generated from the variable current source IV, the sensing unit 271b may converts the field voltage Vf into the first DC voltage VDC1 based on the gain signal GNS to output the first DC voltage VDC1 through the first node N1.

Referring to FIG. 13 again, the current-voltage conversion unit 272 may convert the inner current lint provided from the power generation unit 211 into a second DC voltage VDC2. For example, the current-voltage conversion unit 272 may generate the second DC voltage VDC2 proportional to an intensity of the inner current lint and the gain signal GNS provided from the CPU 220. As described above, the CPU 220 provides the gain signal GNS having the first value to the current-voltage conversion unit 272 during a section of detecting whether an NFC card exists around and in the reader mode and the gain signal GNS having the second value greater than the first value to the current-voltage conversion unit 272 during a section of detecting whether an NFC reader exists around and in the card mode, so that the current-voltage conversion unit 272 may generate the second DC voltage VDC2 having a magnitude in a desired range (that may or may not be predetermined) regardless of the operation modes.

The multiplexer 276 may output one of the first and second DC voltages VDC1 and VDC2 in response to a selection signal SS provided from the CPU 220. For example, when the selection signal SS has a first logic level, the multiplexer 276 may output the first DC voltage VDC1. when the selection signal SS has a second logic level, the multiplexer 276 may output the second DC voltage VDC2. In some example embodiments, the CPU 220 may output the selection signal SS having the first logic level in the reader mode and may determine the logic level of the selection signal SS based on an intensity of an electromagnetic wave received from the NFC leader in the card mode. In some example embodiments, the CPU 220 may determine the logic level of the selection signal SS based on a user selection.

The counting unit 273 may generate a counting value CNT by performing an up-counting operation and may reset the counting value CNT in response to a reset signal RST provided from the CPU 220.

The scanning voltage generation unit 275 may generate a scanning voltage VSCAN which is gradually increased based on the counting value CNT.

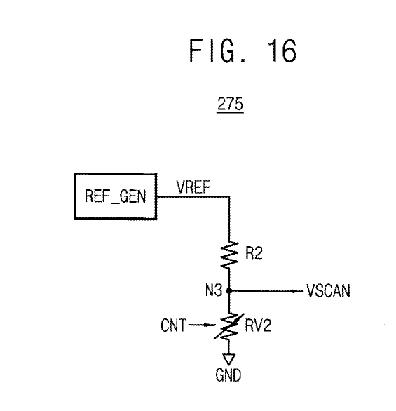

FIG. 16 is a block diagram illustrating one example of the scanning voltage generation unit included in the detection unit of FIG. 13.

Referring to FIG. 16, the scanning voltage generation unit 275 may include a reference voltage generator REF_GEN, a second resistor R2, and a second variable resistor RV2.

The reference voltage generator REF_GEN may generate a reference voltage VREF having a desired magnitude (that may or may not be predetermined).

The second resistor R2 may be connected between the reference voltage generator REF_GEN and the third node N3 and the second variable resistor RV2 may be connected between the third node N3 and the ground voltage GND. The second variable resistor RV2 may have a resistance value corresponding to the counting value CNT.

Since the second resistor R2 and the second variable resistor RV2 are operated as a voltage dividing circuit for dividing the reference voltage VREF, the scanning voltage generation unit 275 may generate the scanning voltage VSCAN having a magnitude proportional to the counting value CNT to output the scanning voltage VSCAN through the third node N3.

Further, since the scanning voltage generation unit 275 controls a rate of increasing a resistance value of the second variable resistor RV2 in proportion to the counting value CNT, the detection unit 270 may control an accuracy of converting the field voltage Vf received through the first and second power terminals L1 and L2 or the inner current Iint provided through the power generation unit 211 into the digital value DV.

Referring to FIG. 13 again, by comparing the output voltage of the multiplexer 276 with the scanning voltage VSCAN provided from the scanning voltage generation unit 275, the multiplexer 276 may output a comparison signal CMP which has a first logic level when the output voltage of the multiplexer 276 is higher than the scanning voltage VSCAN or a second logic level when the output voltage of the multiplexer 276 is lower than the scanning voltage VSCAN.

Since the scanning voltage VSCAN is increased more and more, the comparator 277 may allow the comparison signal CMP to be transited from the first logic level to the second logic level when the magnitude of the scanning voltage VSCAN is equal to or greater than that of the output voltage of the multiplexer 276 while the comparator 277 is outputting the comparison signal CMP of the first logic level.

The latch unit 279 may receive the counting value CNT and the comparison signal CMP, latch the counting value CNT in response to the transition of the comparison signal CMP and output the latched counting value CNT as the digital value DV.

Referring to FIG. 9 again, the CPU 220 may detect an NFC card by comparing the digital value DV with the first threshold voltage Vth1 and may detect an NFC reader by comparing the digital value DV with the second threshold voltage Vth2. Further, the CPU 220 may generate the tuning control signal TCS corresponding to the first optimal frequency (or first frequency with improved performance) based on the digital value DV and may provide the tuning control signal TCS to the tuning unit 260 in the reader mode. In addition, the CPU 220 may generate the tuning control signal TCS corresponding to the second optimal frequency (or second frequency with improved performance) based on the digital value DV and may provide the tuning control signal TCS to the tuning unit 260 in the card mode.

Hereinafter an operation of the NFC device 10a will be described in detail with reference to FIG. 9.

If the NFC device 10a is turned on, the NFC device 10a may perform repeatedly and alternately the operation of detecting an NFC card and the operation of detecting an NFC reader until the NFC card or NFC reader is detected.

The transmit unit 250 may periodically provide the carrier signal CW having a standard voltage Vs to the resonance unit 100 in order to detect an NFC card and the resonance unit 100 may periodically radiate the carrier wave corresponding to the carrier signal CW. The CPU 220 may output the selection signal SS having the first logic level and the detection unit 270 may receive the field voltage Vf generated at the first and second power terminals L1 and L2 while radiating the carrier wave to generate the digital value DV.

As shown in FIG. 3, when the NFC card does not exist around the NFC device 10a, the carrier wave radiated through the resonance unit 100 is not returned because the carrier wave is not reflected from an NFC card, so the field voltage Vf generated at the first and second power terminals L1 and L2 may be substantially equal to the standard voltage Vs. However when an NFC card approaches around the NFC device 10a at time t1, since the carrier wave returns to the NFC card due to the reflection upon the NFC card, the field voltage Vf generated at the first and second power terminals L1 and L2 may be lower than the standard voltage Vs.

Thus, when the voltage corresponding to the digital value DV is lower than the standard voltage Vs by the first threshold voltage Vth1 or more, the CPU 220 may determine that the NFC card is detected.

When the NFC card is detected, the NFC device 10a may be operated in the reader mode. The transmit unit 250 may continuously provide the carrier signal CW to the resonance unit 100 and may continuously radiate the carrier wave corresponding to the carrier signal CW. The CPU 220 may provide the tuning control signal TCS having a sequentially increasing value to the tuning unit 260 and may sequentially increase the capacitance of the capacitive load connected to the resonance unit 100 based on the tuning control signal TCS. Further, whenever the value of the tuning control signal TCS varies under control of the CPU 220, the detection unit 270 may receive the field voltage Vf to generate the digital value DV.

In some example embodiments, the CPU 220 may compare the digital values DV generated according each value of the tuning control signal TCS with each other and may provide the tuning control signal TCS having the value when the digital value DV is maximized to the tuning unit 260. In this case, the resonance frequency of the resonance unit 100 may be substantially equal to the carrier frequency included in the carrier signal CW. Thus, since the maximum voltage is generated from the resonance unit 100, the operation performance of the NFC device 10a may be maximized in the reader mode.

In some example embodiments, the CPU 220 may compare the digital values DV generated according each value of the tuning control signal TCS with each other and may provide the tuning control signal TCS having the value that is obtained by adding the second offset to the value when the digital value DV is maximized to the tuning unit 260. In this case, the resonance frequency of the resonance unit 100 may be different from the carrier frequency included in the carrier signal CW by the first offset frequency corresponding to the first offset. When the maximum voltage is generated from the resonance unit 100, the noise components may be increased too. Thus, in the reader mode, the operation performance of the NFC device 10a may be optimized by setting the resonance frequency of the resonance unit 100 differently from the carrier frequency by the first offset frequency according to a noise removal characteristic of the NFC device 10a.

Then, the NFC device 10a may transmit the request instruction to the NFC card through the transmit unit 250 and may wait for the first time to receive a response to the request instruction. When the response to the request instruction is received from the NFC card for the first time T1, the NFC device 10a may start to transceive data with the NFC card. When the response to the request instruction is not received from the NFC card for the first time T1, the NFC device 10a may repeatedly perform the above-described operation such that the NFC device 10a may tune the resonance frequency of the resonance unit 100.

As describe above, even though the resonance frequency of the resonance unit 100 may vary according to external environment such as temperature or humidity and operation environment such as a distance between the NFC device 10a and the NFC card, the resonance frequency may be periodically tuned, so that the operation performance of the NFC device 10a may be improved.

Meanwhile, when the transmit unit 250 is turned off in order to detect an NFC reader and the resonance unit 100 receives an electromagnetic wave from an outside, the field voltage Vf may be generated at the first and second power terminals L1 and L2 in response to the electromagnetic wave. The CPU 220 may output the selection signal SS having the first logic level and the detection unit 270 may receive the field voltage Vf from the first and second power terminals L1 and L2 to generate the digital value DV.

As shown in FIG. 4, when the NFC reader does not exist around the NFC device 10a, since any electromagnetic waves received from an outside do not exist substantially, the field voltage Vf generated from the resonance unit 100 may be substantially zero. However, as the NFC device 10a approaching an NFC reader starts to receive the carrier wave radiated from the NFC reader at time t2, the resonance unit 100 may generate the field voltage Vf in response to the carrier wave. As the NFC device 10a approaches the NFC reader, the field voltage Vf generated from the resonance unit 100 may be increased more and more. When the NFC device 10a approaches within a desired distance (that may or may not be predetermined) to the NFC reader at time t3, the field voltage Vf generated by the resonance unit 100 may be increased to the level of the second threshold voltage Vth2 or more.

Thus, when the voltage corresponding to the digital value DV is equal to or greater than the second threshold voltage Vth2, the CPU 220 may determine that the NFC card is detected.

When the NFC reader is detected, the NFC device 10a may be operated in the card mode. The CPU 220 may provide the tuning control signal TCS having a sequentially increasing value to the tuning unit 260 and may sequentially increase the capacitance of the capacitive load connected to the resonance unit 100 based on the tuning control signal TCS. Further, whenever the value of the tuning control signal TCS varies under control of the CPU 220, the detection unit 270 may receive the field voltage Vf or the inner current lint to generate the digital value DV.

In some example embodiments, the CPU 220 may compare the digital values DV generated according each value of the tuning control signal TCS with each other and may provide the tuning control signal TCS having the value when the digital value DV is maximized to the tuning unit 260. In this case, the resonance frequency of the resonance unit 100 may be substantially equal to the carrier frequency included in the carrier signal CW received from the NFC reader. Thus, since the maximum voltage is generated from the resonance unit 100, the operation performance of the NFC device 10a may be maximized in the card mode.

In some example embodiments, the CPU 220 may compare the digital values DV generated according each value of the tuning control signal TCS with each other and may provide the tuning control signal TCS having the value that is obtained by adding the second offset to the value when the digital value DV is maximized to the tuning unit 260. In this case, the resonance frequency of the resonance unit 100 may be different from the carrier frequency included in the carrier wave by the second offset frequency corresponding to the second offset. When the maximum voltage is generated from the resonance unit 100, the noise components may be increased too. Thus, in the card mode, the operation performance of the NFC device 10a may be optimized by setting the resonance frequency of the resonance unit 100 differently from the carrier frequency by the first offset frequency according to a noise removal characteristic of the NFC device 10a.

Then, the NFC device 10a may wait for the first time to receive the request instruction from the NFC reader. When the request instruction is received from the NFC reader for the first time T1, the NFC device 10a may start to transceive data with the NFC reader. When the request instruction is not received from the NFC reader for the first time T1, the NFC device 10a may repeatedly perform the above-described operation such that the NFC device 10a may tune the resonance frequency of the resonance unit 100.

As describe above, even though the resonance frequency of the resonance unit 100 may vary according to external environment such as temperature or humidity and operation environment such as a distance between the NFC device 10a and the NFC reader, the resonance frequency may be periodically tuned, so that the operation performance of the NFC device 10a may be improved.

As described above, since the NFC device 10a may independently set the resonance frequency for the reader mode and the card mode, even when the optimal resonance frequency (or frequency with improved performance) required in the reader mode is different from the optical resonance frequency required in the card mode, the NFC device 10a may be set at the optimal frequency (or frequency with improved performance) required for the reader mode and the card mode, respectively.

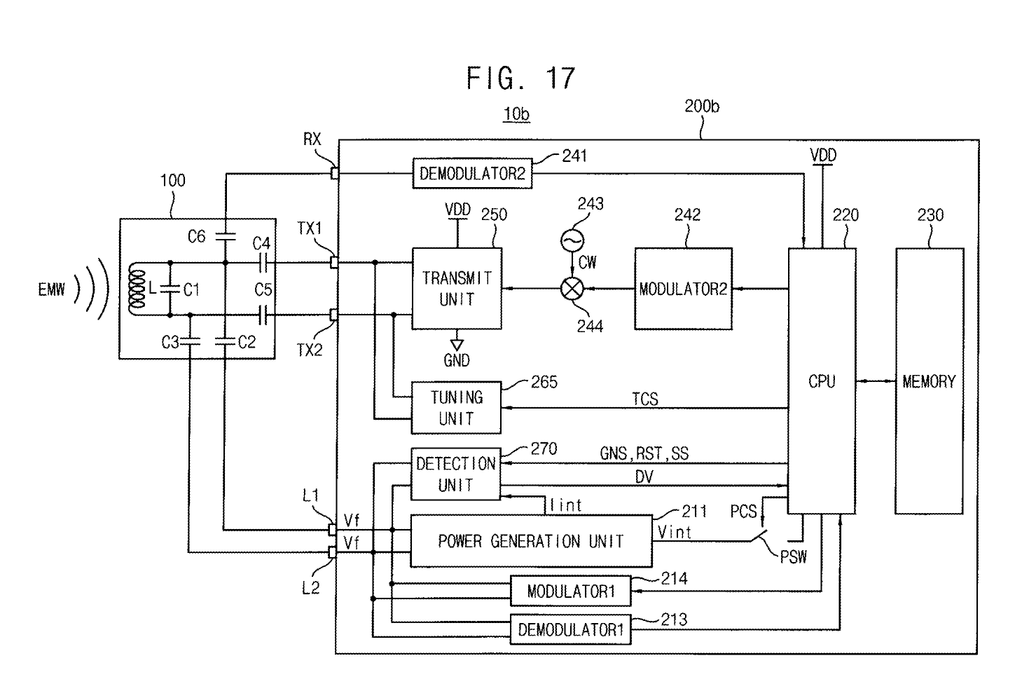

FIG. 17 is a block diagram illustrating another example of the NFC device depicted in FIG. 8.

Referring to FIG. 17, an NFC device 10b may include a resonance unit 100 and an NFC chip 200b.

The NFC device 10b of FIG. 17 is similar to the NFC device 10a of FIG. 9 except that the NFC device 10b of FIG. 17 includes a tuning unit 265 instead of the tuning unit 260.

The tuning unit 265 may connect a capacitive load, which has a capacitance corresponding to a tuning control signal TCS provided from a CPU 220, to the resonance unit 100 through the first and second transmit terminals TX1 and TX2. That is, the tuning unit 260 included in the NFC device 10a of FIG. 9 connects the capacitive load between the first power terminal L1 and the ground voltage GND and between the second power terminal L2 and the ground voltage GND. To the contrary, the tuning unit 265 included in the NFC device 10b of FIG. 17 connects the capacitive load between the first transmit terminal TX1 and the ground voltage GND and between the second transmit terminal TX2 and the ground voltage GND.

Likewise with the first and second power terminals L1 and L2, since the first and second transmit terminals TX1 and TX2 are connected to the resonance unit 100 too, the tuning unit 265 may change the resonance frequency of the resonance unit 100 in the same scheme as that of the tuning unit 260.

Therefore, since the operation of the NFC device 10b of FIG. 17 is substantially the same as that of the NFC device 10a of FIG. 9, the detailed description about the NFC device 10b of FIG. 17 is omitted.

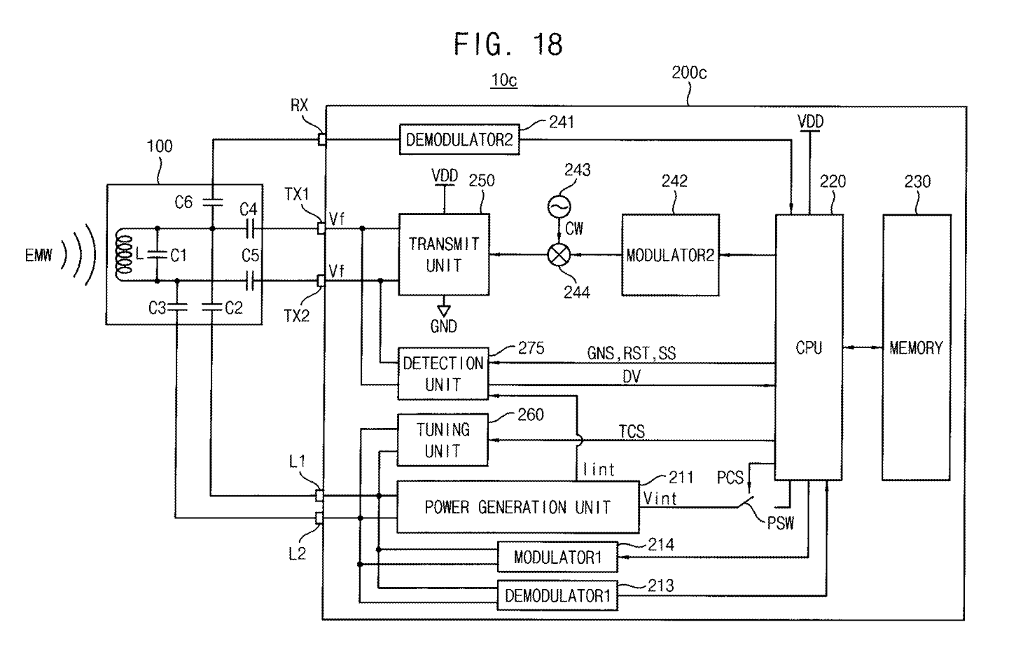

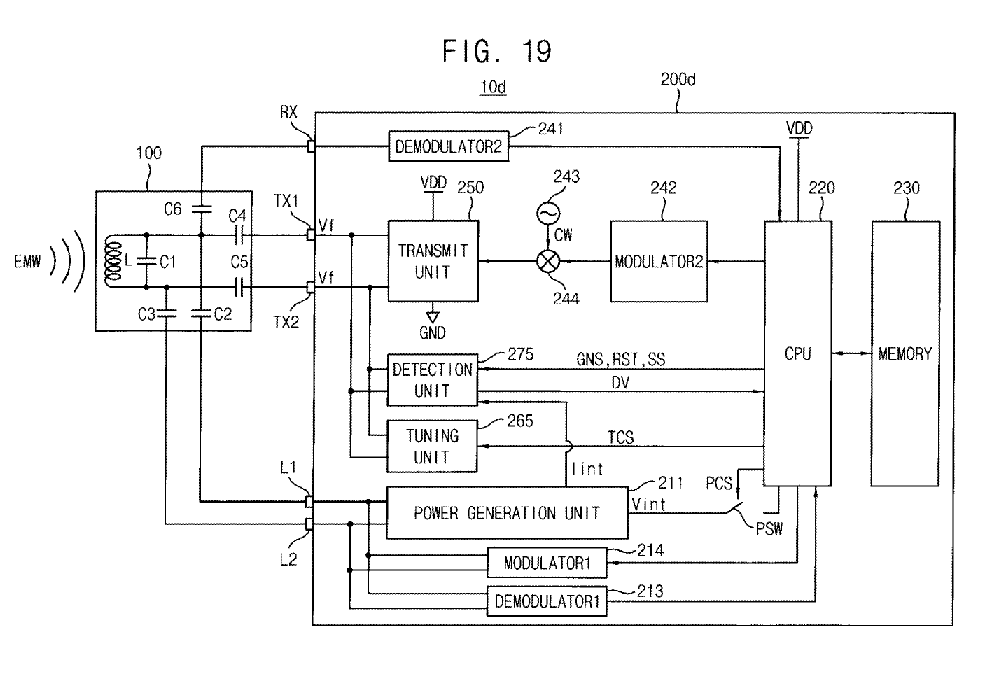

FIG. 18 is a block diagram illustrating still another example of the NFC device depicted in FIG. 8.

Referring to FIG. 18, an NFC device 10c may include a resonance unit 100 and an NFC chip 200c.

The NFC device 10c of FIG. 18 is similar to the NFC device 10a of FIG. 9 except that the NFC device 10c of FIG. 18 includes a detection unit 275 instead of the detection unit 270.

The detection unit 275 is connected to the first and second transmit terminals TX1 and TX2. The detection unit 275 may convert one of the field voltage Vf received through the first and second transmit terminals TX1 and TX2 and the inner current lint provided from the power generation unit 211 into the digital value DV based on the control signals GNS, RST and SS provided from the CPU 220 and may provide the digital value DV to the CPU 220. That is, while the detection unit 270 included in the NFC device 10a of FIG. 9 may receive the voltage of the first and second power terminals L1 and L2 as the field voltage Vf, the detection unit 275 included in the NFC device 10c of FIG. 18 may receive the voltage of the first and second transmit terminals TX1 and TX2 as the field voltage Vf.

Likewise with the first and second power terminals L1 and L2, since the first and second transmit terminals TX1 and TX2 are connected to the resonance unit 100 too, the voltage of the first and second transmit terminals TX1 and TX2 may be substantially equal or similar to the voltage of the first and second power terminals L1 and L2.

Therefore, since the operation of the NFC device 10c of FIG. 18 is substantially the same as that of the NFC device 10a of FIG. 9, the detailed description about the NFC device 10c of FIG. 18 is omitted.

FIG. 19 is a block diagram illustrating still another example of the NFC device depicted in FIG. 8.

Referring to FIG. 19, an NFC device 10d may include a resonance unit 100 and an NFC chip 200d.

The NFC device 10d of FIG. 19 is similar to the NFC device 10a of FIG. 9, the NFC device 10d of FIG. 19 except that the NFC device 10d of FIG. 19 includes the tuning unit 265 and the detection unit 275 instead of the tuning unit 260 and the detection unit 270.

The tuning unit 265 is the same as the tuning unit 265 included in the NFC device 10b of FIG. 17 and the detection unit 275 is the same as the detection unit 275 included in the NFC device 10c of FIG. 18.

Therefore, since the operation of the NFC device 10d of FIG. 19 is substantially the same as that of the NFC device 10a of FIG. 9, the detailed description about the NFC device 10d of FIG. 19 is omitted.

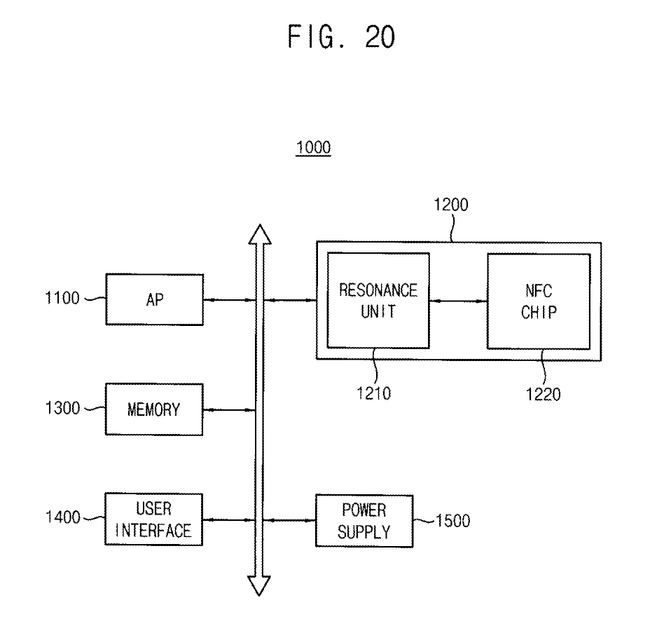

FIG. 20 is a block diagram illustrating an electronic system according to some example embodiments.

Referring to FIG. 20, an electronic system 1000 includes an application processor (AP) 1100, an NFC device 1200, a memory device 1300, a user interface 1400, and a power supply 1500. In some example embodiments, the electronic system 1000 may be a mobile phone, a smart phone, a personal digital assistant (PDA), a portable multimedia player (PMP), a digital camera, a music player, a portable game console, a navigation system, a laptop computer, etc.

The application processor 1100 may control overall operations of the electronic system 1000. The application processor 1100 may execute applications, such as a web browser, a game application, a video player, etc. In some example embodiments, the application processor 1100 may include a single core or multiple cores. For example, the application processor 1100 may be a multi-core processor, such as a dual-core processor, a quad-core processor, a hexa-core processor, etc. The application processor 1100 may include an internal or external cache memory.

The memory device 1300 may store data required for an operation of the electronic system 1000. For example, the memory device 1300 may store a boot image for booting the electronic system 1000, output data to be outputted to an external device and input data received from the external device. For example, the memory device 1300 may be an electrically erasable programmable read-only memory (EEPROM), a flash memory, a phase change random access memory (PRAM), a resistance random access memory (RRAM), a nano floating gate memory (NFGM), a polymer random access memory (PoRAM), a magnetic random access memory (MRAM), a ferroelectric random access memory (FRAM), etc.

The NFC device 1200 may provide the output data stored in the memory device 1300 to the external device through NFC and store the input data received from the external device through NFC into the memory device 1300. The NFC device 1200 may include a resonance unit 1210 and an NFC chip 1220. The resonance unit 1210 may generate a field voltage in response to an electromagnetic wave. The NFC chip 1220 may detect whether an NFC card or an NFC reader exists around based on a magnitude of the field voltage. The NFC chip 1220 may set a resonance frequency of the resonance unit with a first optimal frequency (or first frequency with improved performance) based on a magnitude of the field voltage and operate in a reader mode when the NFC card is detected. The NFC chip 1220 may set the resonance frequency of the resonance unit with a second optimal frequency (or second frequency with improved performance) based on at least one of the magnitude of the field voltage and a magnitude of an inner current generated in response to the electromagnetic wave and to operate in a card mode when the NFC reader is detected. The NFC device 1200 may be embodied with the NFC device 10 of FIG. 8. A structure and an operation of the NFC device 10 are described above with reference to FIGS. 8 to 19. Therefore, a detail description of the NFC device 1200 will be omitted.

The user interface 1400 may include at least one input device, such as a keypad, a touch screen, etc., and at least one output device, such as a speaker, a display device, etc. The power supply 1500 may supply a power supply voltage to the electronic system 1000.

In some example embodiments, the electronic system 1000 may further include an image processor, and/or a storage device, such as a memory card, a solid state drive (SSD), a hard disk drive (HDD), a CD-ROM, etc.

In some example embodiments, the electronic system 1000 and/or components of the electronic system 1000 may be packaged in various forms, such as package on package (PoP), ball grid arrays (BGAs), chip scale packages (CSPs), plastic leaded chip carrier (PLCC), plastic dual in-line package (PDIP), die in waffle pack, die in wafer form, chip on board (COB), ceramic dual in-line package (CERDIP), plastic metric quad flat pack (MQFP), thin quad flat pack (TQFP), small outline IC (SOIC), shrink small outline package (SSOP), thin small outline package (TSOP), system in package (SIP), multi-chip package (MCP), wafer-level fabricated package (WFP), or wafer-level processed stack package (WSP).

While example embodiments have been particularly shown and described, it will be While example embodiments have been particularly shown and described, it will be understood by those of ordinary skill in the art that various changes in form and details may be made therein without departing from the spirit and scope of the present invention as defined by the following claims.

What is claimed is:

1. A method of controlling a resonance frequency of a Near Field Communication (NFC) device that includes a resonance unit to transceive data through an electromagnetic wave and an NFC chip, the method comprising:
detecting whether an NFC card or an NFC reader exists around the NFC device;
when the NFC card is detected, setting a resonance frequency of the resonance unit as a first optimal frequency based on a magnitude of a voltage generated from the resonance unit while a carrier wave is radiated to the NFC card through the resonance unit; and
when the NFC reader is detected, setting the resonance frequency of the resonance unit as a second optimal frequency based on at least one of the magnitude of the voltage generated from the resonance unit in response to the electromagnetic wave received from the NFC reader and a magnitude of an inner current generated from the NFC chip in response to the electromagnetic wave.

2. The method of claim 1, wherein the setting the resonance frequency as the first optimal frequency comprises:
continuously radiating the carrier wave to the NFC card through the resonance unit;
repeatedly measuring a first voltage generated from the resonance unit while varying the resonance frequency during radiation of the carrier wave;
determining the first optimal frequency based on the resonance frequency obtained when the first voltage becomes a maximum voltage from among the measured voltages; and
adjusting the resonance frequency to the first optimal frequency.

3. The method of claim 2, wherein the repeatedly measuring the first voltage while varying the resonance frequency comprises:
sequentially increasing a capacitance of a capacitive load connected to the resonance unit; and
measuring the first voltage with respect to each capacitance of the capacitive load.

4. The method of claim 3, wherein the measuring the first voltage comprises:
generating a count value by performing an up-counting operation;
generating a scanning voltage that is sequentially increased based on the count value;
comparing a magnitude of the first voltage with a magnitude of the scanning voltage; and
generating the count value obtained at a time when the magnitude of the scanning voltage is greater than or equal to the magnitude of the first voltage as a digital value.

5. The method of claim 4, wherein the determining the first optimal frequency based on the resonance frequency obtained when the first voltage becomes the maximum voltage from among the measured voltages comprises:
determining the capacitance of the capacitive load obtained when the digital value is maximized as a first optimal capacitance by comparing the digital values generated with respect to each capacitance of the capacitive load, and
wherein the adjusting the resonance frequency to the first optimal frequency comprises:
setting the capacitance of the capacitive load into the first optimal capacitance.

6. The method of claim 4, wherein the determining the first optimal frequency based on the resonance frequency obtained when the first voltage becomes the maximum voltage from among the measured voltages comprises:
determining a value, which is obtained by adding a first offset capacitance to the capacitance of the capacitive load obtained when the digital value is maximized from among the digital values generated with respect to each capacitance of the capacitive load, as a first optimal capacitance, and
wherein adjusting the resonance frequency to the first optimal frequency comprises:
adjusting the capacitance of the capacitive load to the first optical capacitance.

7. The method of claim 1, wherein the setting the resonance frequency as the second optimal frequency comprises:
repeatedly measuring one selected from a second voltage, which is generated from the resonance unit in response to the electromagnetic wave received from the NFC reader, and the inner current while varying the resonance frequency;
determining the second optimal frequency based on the resonance frequency obtained when the selected one is maximized; and
adjusting the resonance frequency to the second optimal frequency.

8. The method of claim 1, wherein detecting whether the NFC card or the NFC reader exists around the NFC device comprises:
determining that the NFC card is detected when a voltage, which is generated from the resonance unit while the carrier wave having a standard voltage is periodically radiated through the resonance unit, is lower than the standard voltage by a first threshold voltage or more; and
determining that the NFC reader is detected when a voltage, which is generated from the resonance unit in response to an electromagnetic wave received from outside the NFC device and is periodically measured, is greater than or equal to a second threshold voltage.

9. The method of claim 8, wherein the determining that the NFC card is detected and the determining that the NFC reader is detected are performed repeatedly and alternately until the NFC card or the NFC reader is detected.

10. The method of claim 1, further comprising:
transmitting a request instruction to the NFC card; and
repeatedly performing the setting the resonance frequency as the first optical frequency when a response to the request instruction is not received from the NFC card during a first time period.

11. The method of claim 1, further comprising:
repeatedly performing the setting the resonance frequency as the second optical frequency when a request instruction is not received from the NFC reader during a first time period.

12. A Near Field Communication (NFC) device, comprising:
a resonance unit configured to generate a field voltage in response to an electromagnetic wave; and
an NFC chip configured to detect whether an NFC card or an NFC reader exists around the NFC device based on a magnitude of the field voltage, configured to set a resonance frequency of the resonance unit as a first optimal frequency based on the magnitude of the field voltage and to operate in a reader mode when the NFC card is detected, and configured to set the resonance frequency of the resonance unit as a second optimal frequency based on at least one of the magnitude of the field voltage and a magnitude of an inner current generated in response to the electromagnetic wave and to operate in a card mode when the NFC reader is detected.

13. The NFC device of claim 12, wherein the NFC chip comprises:
a transmit unit configured to provide a carrier signal to the resonance unit through a transmit terminal;
a power generation unit configured to generate the inner current and an inner voltage having a desired voltage level using a voltage provided from the resonance unit;
a detection unit configured to convert one of the magnitude of the field voltage and the magnitude of the inner current into a digital value;
a tuning unit configured to connect a capacitive load having a capacitance corresponding to a tuning control signal to the resonance unit; and
a Central Processing Unit (CPU) configured to control the transmit unit, the detection unit, and the tuning unit, to detect the NFC card based on the digital value and a first threshold voltage, to detect the NFC reader based on the digital value and a second threshold voltage, to generate the tuning control signal corresponding to the first optimal frequency based on the digital value in the reader mode, and to generate the tuning control signal corresponding to the second optimal frequency based on the digital value in the card mode.

14. The NFC device of claim 13, wherein the tuning unit is further configured to connect the capacitive load between a terminal receiving the field voltage from the resonance unit and a ground voltage.

15. The NFC device of claim 13, wherein the tuning unit is further configured to connect the capacitive load between the transmit terminal and a ground voltage.

16. The NFC device of claim 13, wherein the transmit unit is further configured to periodically provide the carrier signal to the resonance unit while detecting the NFC card,
wherein the detection unit is further configured to receive the field voltage from the resonance unit to generate the digital value while the resonance unit radiates a carrier wave corresponding to the carrier signal, and
wherein the CPU is further configured to determine that the NFC card is detected when a voltage corresponding to the digital value is lower than a standard voltage by the first threshold voltage or more.

17. The NFC device of claim 13, wherein the detection unit is further configured to receive the field voltage from the resonance unit to generate the digital value while detecting the NFC reader, and
wherein the CPU is further configured to determine that the NFC reader is detected when a voltage corresponding to the digital value is greater than or equal to the second threshold voltage.

18. The NFC device of claim 13, wherein the transmit unit is further configured to continuously provide the carrier signal to the resonance unit when the NFC card is detected,
wherein the CPU is further configured to generate the tuning control signal having a value sequentially increased,
wherein the tuning unit is further configured to sequentially increase the capacitance of the capacitive load based on the tuning control signal,
wherein the detection unit is further configured to generate the digital value based on the field voltage whenever a value of the tuning control signal is increased, and
wherein the CPU is further configured to compare the digital values generated with respect to each value of the tuning control signal with each other and provide the tuning unit with the tuning control signal having the value of the tuning control signal when the digital value is maximized.

19. The NFC device of claim 13, wherein the CPU is further configured to generate the tuning control signal having a value sequentially increased when the NFC reader is detected,
wherein the tuning unit is further configured to sequentially increase the capacitance of the capacitive load based on the tuning control signal,
wherein the detection unit is further configured to generate the digital value based on one of the field voltage and the inner current whenever a value of the tuning control signal is increased, and
wherein the CPU is further configured to compare the digital values generated with respect to each value of the tuning control signal with each other and provide the tuning unit with the tuning control signal having the value of the tuning control signal when the digital value is maximized.

20. The NFC device of claim 13, wherein the detection unit comprises:
a sensing unit configured to generate a first direct current (DC) voltage proportional to the magnitude of the field voltage and a gain signal;
a current-voltage conversion unit configured to generate a second DC voltage proportional to the magnitude of the inner current and the gain signal;
a multiplexer configured to output one of the first and second DC voltages in response to a selection signal;
a counting unit configured to generate a counting value by performing an up-counting operation;
a scanning voltage generation unit configured to generate a scanning voltage that is sequentially increased based on the counting value;
a comparator configured to output a comparison signal having a first logic level when an output voltage of the multiplexer is greater than the scanning voltage and a second logic level when the output voltage of the multiplexer is less than the scanning voltage; and
a latch unit configured to store the counting value as the digital value in response to a transition of the comparison signal.

21. The NFC device of claim 20, wherein the CPU is further configured to provide the gain signal having a first value to the sensing unit during a section of detecting the NFC card and in the reader mode, and
wherein the CPU is further configured to provide the gain signal having a second value to the sensing unit during a section of detecting the NFC reader and in the card mode.

22. The NFC device of claim 20, wherein the sensing unit comprises:
a rectifier circuit configured to rectify the field voltage to output the rectified field voltage to a first node;
a first resistor connected between the first node and a second node; and
a first variable resistor connected between the second node and a ground voltage and having a resistance value with a magnitude corresponding to the gain signal;
wherein the sensing unit is further configured to output the first DC voltage through the second node.

23. The NFC device of claim 20, wherein the sensing unit comprises:
a rectifier circuit configured to rectify the field voltage to output the rectified field voltage to a first node; and
a variable current source connected between the first node and a ground voltage to generate a current having a magnitude corresponding to the gain signal;
wherein the sensing unit is further configured to output the first DC voltage through the first node.

24. The NFC device of claim 20, wherein the scanning voltage generation unit comprises:
a reference voltage generator configured to generate a reference voltage;
a second resistor connected between the reference voltage generator and a third node; and
a second variable resistor connected between the third node and a ground voltage;
wherein the scanning voltage generation unit outputs the scanning voltage through the third node.

25. An electronic system, comprising:
a memory unit configured to store data;
a Near Field Communication (NFC) device configured to transmit the data stored in the memory unit through NFC and to store data received from outside the NFC device in the memory unit; and
an application processor configured to control operations of the NFC device and the memory unit;
wherein the NFC device comprises:
a resonance unit configured to generate a field voltage in response to an electromagnetic wave; and
an NFC chip configured to detect whether an NFC card or an NFC reader exists around the NFC device based on a magnitude of the field voltage, configured to set a resonance frequency of the resonance unit as a first optimal frequency based on the magnitude of the field voltage and to operate in a reader mode when the NFC card is detected, and configured to set the resonance frequency of the resonance unit as a second optimal frequency based on at least one of the magnitude of the field voltage and a magnitude of an inner current generated in response to the electromagnetic wave and to operate in a card mode when the NFC reader is detected.

26. A method of controlling a resonance frequency of a Near Field Communication (NFC) device that includes a resonance unit to transceive data through an electromagnetic wave and an NFC chip, the method comprising:
detecting whether an NFC card or an NFC reader exists within a communication range of the NFC device;
when the NFC card is detected, setting a resonance frequency of the resonance unit as a first frequency based on a magnitude of a voltage generated from the resonance unit while a carrier wave is radiated to the NFC card through the resonance unit; and
when the NFC reader is detected, setting the resonance frequency of the resonance unit as a second frequency based on at least one of the magnitude of the voltage generated from the resonance unit in response to the electromagnetic wave received from the NFC reader and a magnitude of an inner current generated from the NFC chip in response to the electromagnetic wave.

27. The method of claim 26, wherein the first frequency is different from the second frequency.

28. The method of claim 26, wherein when the NFC card is detected, the setting the resonance frequency of the resonance unit as the first frequency is based on a maximum magnitude of the voltage generated from the resonance unit while the carrier wave is radiated to the NFC card through the resonance unit.

29. The method of claim 26, wherein when the NFC reader is detected, the setting the resonance frequency of the resonance unit as the second frequency is based on at least one of a maximum magnitude of the voltage generated from the resonance unit in response to the electromagnetic wave received from the NFC reader and the magnitude of the inner current generated from the NFC chip in response to the electromagnetic wave.

30. The method of claim 26, wherein when the NFC reader is detected, the setting the resonance frequency of the resonance unit as the second frequency is based on at least one of the magnitude of the voltage generated from the resonance unit in response to the electromagnetic wave received from the NFC reader and a maximum magnitude of the inner current generated from the NFC chip in response to the electromagnetic wave.

31. The method of claim 26, wherein when the NFC reader is detected, the setting the resonance frequency of the resonance unit as the second frequency is based on at least one of a maximum magnitude of the voltage generated from the resonance unit in response to the electromagnetic wave received from the NFC reader and a maximum magnitude of the inner current generated from the NFC chip in response to the electromagnetic wave.
